(19) United States
(12) Patent Application Publication
(10) Pub. No.: US 2022/0379527 A1
(43) Pub. Date: Dec. 1, 2022

(54) EMBEDDING OBJECTS IN CASTINGS

(71) Applicant: SPIDERMIND GAMES LIMITED, Tonbridge (GB)

(72) Inventors: Jon LUNN, Sutherland (GB); Michael STARKEY, Kent, OH (US)

(21) Appl. No.: 17/752,389

(22) Filed: May 24, 2022

Related U.S. Application Data
(60) Provisional application No. 63/194,173, filed on May 27, 2021.

(51) Int. Cl. B29C 39/10; B29C 39/02; B29C 39/38; A23G 9/08; A23G 9/24; A23G 9/48

(52) U.S. Cl. CPC B29C 39/10; B29C 39/021; B29C 39/38; A23G 9/083; A23G 9/24; A23G 9/48; A23G 2220/20

(57) ABSTRACT

An apparatus for embedding objects in castings made in batch includes a base comprising a plurality of cavities for molding, each cavity corresponding to an item to be molded; a framework comprising a plurality of gripping mechanisms for suspending objects from the framework into the cavities for embedding the objects within the molded items, each gripping mechanism being configured to release a respective object upon actuation; and, a lifting mechanism transitionable for effecting actuation of the plurality of gripping mechanisms such that objects suspended by the gripping mechanisms are released. A method of casting includes partially filling a plurality of cavities with a liquid; suspending objects from a framework; simultaneously partially sinking the objects into the liquid in the cavities; releasing the objects from the framework after at least partially hardening of the liquid; and fully immersing the objects with the liquid.

### COPYRIGHT STATEMENT

Any new and original work of authorship in this is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The invention generally relates to embedding objects in castings and, in particular, apparatus and methods for embedding objects in castings in a uniform orientation relative to one or more outer molded sides of the castings. Preferably, the embedding of the objects in castings is done in a batch manufacturing process, and the items comprise gaming dice. In an exemplary preferred embodiment, the object embedded in a gaming die comprises an eyeball and, specifically, an eyeball resembling the “Eye of Sauron” also known as the “Great Eye” from the Lord of the Rings® trilogy.

It is known to embed objects in castings during the molding process and, in particular, to embed objects in gaming dice that are molded. The method by which this is achieved is to prefill a small amount of resin within a mold. This prefill is left to cure. Once the prefilled has been cured, the object is manually dropped into the mold on top of the cured resin within the cavity of the mold. This is done through a small opening in the mold. The cavity of the mold is then completely filled and the fill cured. The spatial orientation of the resulting embedded object within the mold cannot be accurately determined because the positioning of the object relative to the cured prefill resin was not preset, with the resulting embedded object have a wide range of possible orientations once the final molded item is finished. This problem is exacerbated when the object is generally round because the object will tend to roll around when dropped into the prefilled cavity.

Accordingly, it is believed that a need exists for apparatus and methods for molding items in batch in which embedded objects have a predetermined orientation relative to one or more outer molded sides of the resulting molded items.

### SUMMARY OF THE INVENTION

The invention includes many aspects and features. Moreover, while many aspects and features relate to, and are described in, the context of molding processes using resins, the invention is not limited to use only in such context, as will become apparent from the following summaries and detailed descriptions of aspects, features, and one or more embodiments of the invention. For example, many aspects and features of the invention can be utilized in suspending objects in ice cubes.

Accordingly, in an aspect of the invention an apparatus for embedding an object in a casting comprises: a base comprising a cavity for molding, the cavity corresponding to an item to be molded; a framework comprising a gripping mechanism for suspending the object from the framework into the cavity for embedding the object within the molded item, the gripping mechanism being configured to release the object upon actuation; and a lifting mechanism transitionable for effecting actuation of the gripping mechanism such that the object suspended by the gripping mechanism is released.

In another aspect of the invention an apparatus for embedding objects in castings made in batch comprises: a base comprising a plurality of cavities for molding, each cavity corresponding to an item to be molded; a framework comprising a plurality of gripping mechanisms for suspending objects from the framework into the cavities for embedding the objects within the molded items, each gripping mechanism being configured to release a respective object upon actuation; and a lifting mechanism transitionable for effecting actuation of the plurality of gripping mechanisms such that objects suspended by the gripping mechanisms are released.

In a feature, the framework further comprises a plurality of ejection pins attached to a top plate; and each gripping mechanism slides on a respective ejection pin.

In a feature, the framework further comprises a plurality of ejection pins attached to a top plate; each gripping mechanism slides on a respective ejection pin; each gripping mechanism preferably is spring-biased in a direction away from the top plate; and a spring preferably is concentrically wound about a said ejection pin and spring-biases a said gripping mechanism away from the top plate.

In a feature, the framework further comprises a plurality of ejection pins attached to a top plate; each gripping mechanism slides on a respective ejection pin; and the framework further comprises a plurality of locking pins each of which is located on a respective ejection pin and limits downward movement of the gripping mechanism on said respective ejection pin.

In a feature, the framework further comprises a plurality of ejection pins attached to a top plate; each gripping mechanism slides on a respective ejection pin; and the downward extent of each ejection pin relative to the top plate is independently adjustable.

In another feature, the framework further comprises a plurality of downwardly extending stops each of which limits the upward sliding movement of a said gripping mechanism relative to the top plate. Preferably, the downward extent of each stop relative to the top plate is independently adjustable.

In another feature, each gripping mechanism is retractable and the lifting mechanism is configured to retract the gripping mechanisms thereby effecting actuation of the plurality of gripping mechanisms.

In another feature, the pillars extend from a top of the framework downwardly through holes in the lifting mechanism and into holes in the base and support the top of the framework above and in fixed disposition relative to the base; and the lifting mechanism is configured to be lifted and transitioned along the pillars in a direction from the base toward the top of the framework while engaging and causing the gripping mechanisms to release objects suspended by the gripping mechanisms.

In another feature, alignment rods extend through holes in the lifting mechanism and into holes in the base for aligning the lifting mechanism relative to the base when seated thereon; and the framework is removable from the base while the lifting mechanism is seated on the base.

In another feature, the base comprises a multi-cavity mold.

In another feature, the base comprises a plurality of multi-cavity molds that are interconnected together.

In another feature, the base comprises a plurality of single-cavity molds that are interconnected together.

In another feature, the framework comprises a plurality of individual gripping mechanisms that are interconnected together.

In another feature, the framework comprises a rectangular matrix of a plurality of gripping mechanism that are removably connected together, and the base comprises a corresponding matrix of a plurality of cavities, whereby the number of castings that can be made in batch is adjustable.

In another feature, the apparatus is configured to be manually operated by hand.

In another feature, the lifting mechanism is configured to be manually operated by hand.

In another feature, the castings comprise ice cubes, and the embedded objects comprise are edible.

In another feature, the castings comprise multisided dice. This may include, for example, three-sided dice; six-sided dice; eight-sided dice; ten-sided dice; twelve-sided dice; and twenty-sided dice.

In another feature, the objects themselves are separately molded beforehand.

In another aspect, an apparatus for embedding objects in castings made in batch comprises: a base comprising a plurality of cavities for molding, each cavity corresponding to an item to be molded; a framework comprising a plurality of gripping mechanisms for suspending objects from the framework into the cavities for embedding the objects within the molded items; and means for releasing the objects suspended by the gripping mechanisms within the cavities after partial filling of the cavities with and hardening of a liquid.

In another aspect, an apparatus for embedding objects in castings made in batch comprises: a base comprising a plurality of cavities for molding, each cavity corresponding to an item to be molded; a framework comprising a plurality of retractable gripping mechanisms for suspending objects from the framework into the cavities for embedding the objects within the molded items, each gripping mechanism being configured to release a respective object upon being retracted; and a lifting mechanism transitionable for effecting retraction of the plurality of gripping mechanisms such that objects suspended by the gripping mechanisms are released.

In another aspect, an apparatus for positioning objects within cavities of a mold for embedding the objects within molded items formed by the cavities comprises: a framework comprising a plurality of gripping mechanisms for suspending the objects from the framework into the cavities, the gripping mechanisms being configured to release the suspended objects upon actuation; and a lifting mechanism transitionable for effecting actuation of the gripping mechanisms such that the suspended objects are released.

In a feature, the lifting mechanism is manually transitionable for effecting actuation of the gripping mechanisms such that the suspended objects are released.

In another aspect, an apparatus for positioning objects within cavities of a mold for embedding the objects within molded items formed by the cavities comprises: a framework comprising a plurality of gripping mechanisms for suspending the objects from the framework into the cavities, the gripping mechanisms being configured to release the suspended objects upon actuation; and means for effecting actuation of the gripping mechanisms such that the suspended objects are released.

In a feature, the means is manually operable for effecting actuation of the gripping mechanisms such that the suspended objects are released.

In another aspect, an apparatus for positioning an object within a cavity of a mold for embedding the object within a molded item formed by the cavity comprises: a framework comprising a gripping mechanism for suspending the object from the framework into the cavity, the gripping mechanism being configured to release the suspended object upon actuation; and a lifting mechanism transitionable for effecting actuation of the gripping mechanism such that the suspended object is released.

In a feature, the lifting mechanism is manually transitionable for effecting actuation of the gripping mechanism such that the suspended object is released.

In another aspect, an apparatus for positioning an object within a cavity of a mold for embedding the object within a molded item formed by the cavity comprises: a framework comprising a gripping mechanism for suspending the object from the framework into the cavity, the gripping mechanism being configured to release the suspended object upon actuation; and means for effecting actuation of the gripping mechanism such that the suspended object is released.

In a feature, the means is manually operable for effecting actuation of the gripping mechanism such that the suspended object is released.

In another aspect, a method of casting using a multi-cavity mold comprises: partially filling a plurality of cavities of the multi-cavity mold with a liquid, the plurality of cavities comprising three or more cavities; simultaneously for each cavity that has been partially filled with the liquid, partially sinking an object into the liquid in said cavity; and after at least partially hardening of the liquid partially filled in said cavities with the objects partially sunk therein, fully immersing the objects that have been partially sunk by continuing to fill said cavities with the liquid, whereby upon further hardening a casting is formed in each said cavity having a respective said object embedded therein.

In a feature, the method further comprises positioning the objects in gripping mechanisms suspended from a framework and using the framework to sink the objects within the liquid within the cavities, identical objects being identically oriented relative to their respective gripping mechanisms.

In a feature, the step of partially filling the plurality of cavities is performed simultaneously for each cavity.

In a feature, the step of fully immersing the objects is performed by simultaneously filling said cavities.

In a feature, at least a subset of said plurality of said cavities are identical in dimensions and orientation, identical objects are partially sunk into the liquid in said cavities of said subset, and the identical objects have the same orientation relative to the direction of sinking.

In a feature, each casting formed in each said cavity is a die.

In a feature, the castings comprise dice.

In a feature, the castings comprise ice cubes.

In a feature, the objects are edible.

In a feature, the liquid comprises a resin.

In a feature, the liquid comprises water.

In a feature, the liquid is hardened by freezing.

In a feature, the liquid is hardened by heating.

In a feature, the liquid is hardened using a chemical.

In another aspect, a method of casting using a mold comprises: suspending the object from a framework; partially filling a cavity of a mold with a liquid; positioning the framework over the mold such that the suspended object is sunk into the liquid partially filling the cavity of the mold; after at least partial hardening of the liquid within the cavity of the mold with the object partially sunk into therein, fully immersing the object by continuing to fill the cavity with the liquid, whereby upon further hardening a casting is formed in the cavity having the object embedded therein.

In yet another aspect of the invention, an apparatus for embedding an object in a casting, comprises: a first mold component comprising a cavity for molding a first portion of an item to be molded; a gripping mechanism for suspending an object into the cavity for embedding the object partially within the first portion of the item to be molded, the gripping mechanism being configured to release the object upon actuation; and a second mold component comprising a cavity for molding a remaining portion of the item to be molded. The first mold component is configured to interchangeably receive in respective predetermined orientations the gripping mechanism and the second mold component.

In a feature, the gripping mechanism comprises a clip.

In a feature, the gripping mechanism is biased into gripping engagement with the object.

In a feature, the gripping mechanism is actuated by being pulled upward from the cavity of the first mold component.

In a feature, the gripping mechanism is configured for manual removal from the first mold.

In another aspect, a method for embedding an object in an item being molded comprises: molding a first portion of an item by filling a cavity of a first mold component and suspending an object into the cavity for embedding the object partially within the first portion of the item; and molding a remaining portion of the item by positioning a second mold component over the first mold component and filing a cavity of the second mold component such that the object also is partially received within the cavity of the second mold component and embedded within the remaining portion of the molded item.

In a feature, the method further comprises suspending the object into the cavity of the first mold component using a gripping mechanism. The gripping mechanism preferably comprises a clip and is biased into gripping engagement with the object. The gripping mechanism also may be configured for manual insertion and removal.

Still additional aspects and features are implicitly disclosed in the drawings and the detailed description set forth below.

In addition to the aforementioned aspects and features of the invention, it should be noted that the invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the invention now will be described in detail with reference to the accompanying drawings.

FIG. 1 is an elevational side view of an embodiment of the invention in accordance with one or more aspects and features.

FIG. 2 is an elevational view of a single-cavity mold used in the embodiment of FIG. 1.

FIG. 3 is an elevational view of the single-cavity mold of FIG. 2 and a filling apparatus.

FIG. 4 is an elevational view of the filling apparatus of FIG. 2 being placed on top of and in alignment with the single-cavity mold of FIG. 2.

FIG. 5 is an elevational view of the filling apparatus of FIG. 2 properly placed on top of and aligned with the single-cavity mold of FIG. 2.

FIGS. 6-8 include the elevational view of FIG. 5 and collectively illustrate the partial filling of the cavity of the single-cavity mold, which is now shown in cross-section.

FIG. 9 is an elevational view of the filling apparatus being removed from the single-cavity mold of FIG. 10 the removal of the filling apparatus from the sing-cavity mold.

FIG. 10 is an elevational view of the filling apparatus separated from the single-cavity mold of FIG. 8.

FIG. 11 is an elevational view of the resulting single-cavity mold of FIG. 8 with the cavity having been partially filled with a liquid.

FIG. 12 is an elevational view of the single-cavity mold of FIG. 11 and, additionally, an object-positioning member and a lifting mechanism (shown in cross-section), both of which are used in the embodiment of FIG. 1.

FIG. 13 is an elevational view of the object-positioning member of FIG. 11 seated on top of the single-cavity mold with the lifting mechanism extending in-between the object-positioning member and the single-cavity mold.

FIG. 14 is an elevational view similar to that of FIG. 13, wherein the lifting mechanism has been lifted slightly to the point where an ejection pin of a gripping mechanism of the object-positioning member engages an object that is suspended by the gripping mechanism of the object-positioning member of FIG. 11.

FIG. 15 is an elevational view similar to that of FIG. 14, wherein the object is seen as having been released from the gripping mechanism by engagement of the ejection pin with the object.

FIG. 16 is an elevational view similar to that of FIG. 15, wherein the gripping mechanism is engaged by a stop of the object-positioning member and is thereby precluded from further retraction relative to the top of the object-positioning member.

FIG. 17 is an elevational view similar to that of FIG. 16 illustrating that further lifting of the lifting mechanism results in withdrawal of the object-positioning member from the single-cavity mold.

FIG. 18 is an elevational view similar to that of FIG. 17 illustrating that further lifting of the lifting mechanism results in the separation of the object-positioning member from the single-cavity mold.

FIG. 19 is an elevational view of the resulting single-cavity mold of FIG. 18 with the cavity having been partially filled with a liquid with the object correctly positioned within the cavity, the object having been partially sunk within the liquid.

FIG. 20 is an elevational view of the single-cavity mold of FIG. 19 and the filling apparatus of FIGS. 3-10.

FIG. 21 is an elevational view of the filling apparatus of FIG. 20 being placed on top of and in alignment with the single-cavity mold of FIG. 20.

FIG. 22 is an elevational view of the filling apparatus of FIG. 20 properly placed on top of and aligned with the single-cavity mold of FIG. 20.

FIGS. 23-25 include the elevational view of FIG. 22 and collectively illustrate the remaining filling of the cavity of the single-cavity mold.

FIG. 26 is an elevational view of the filling apparatus being removed from the single-cavity mold of FIG. 25 with the object having been fully immersed in the liquid within the cavity.

FIG. 27 is an elevational view of the filling apparatus separated from the single-cavity mold of FIG. 26.

FIG. 28 is an elevational view of the resulting molded item having been removed from the single-cavity mold of FIG. 27.

FIG. 29 is an elevational view similar to that of FIG. 28 once the molded item has been finished and is ready for sale or commercial use.

FIG. 30 is an isometric view of the finished molded item of FIG. 29.

FIG. 31 is a photograph of an elevational view of a prototype gripping mechanism, ejection pin, limiting pin, and spring in accordance with one or more aspects and features of the invention.

FIG. 32 is a photograph of an elevational view the prototype of FIG. 31 wherein an object comprising a plastic eyeball is retained by the gripping arms of the gripping mechanism.

FIG. 33 is a photograph of another elevational view of the prototype of FIG. 32 including eyeball.

FIG. 34 is a photograph of a bottom view of the prototype of FIG. 32 including eyeball.

FIG. 35 is a photograph of an elevational view of a framework comprising a plurality of the gripping mechanisms and other components shown in FIG. 31.

FIG. 36 is a photograph of a perspective view of a bottom of the framework shown in FIG. 35.

FIG. 37 is a photograph of a perspective view of a bottom of the framework of FIG. 35, wherein different color eyeballs are retained by the gripping mechanisms and have been property oriented for sinking into partially filled cavities of one or more molds.

FIG. 38 is a photograph of an additional perspective view of the bottom of the framework of FIG. 37 including the retained eyeballs.

FIG. 39 is a perspective view of a lower mold component.

FIG. 40 is a top perspective view of the lower mold component of FIG. 39.

FIG. 41 is a perspective view of a bottom of an upper mold component.

FIG. 42 is a top perspective view of the bottom of the upper mold component of FIG. 41.

FIG. 43 is a side elevational view of a gripping mechanism comprising a clip.

FIG. 44 is a perspective view of a top of the gripping mechanism of FIG. 43.

FIG. 45 is a perspective view of a bottom of the gripping mechanism of FIG. 43.

FIG. 46 is a perspective view of the gripping mechanism of FIG. 43 received in a predetermined orientation within a cavity of the lower mold component of FIG. 39.

FIG. 47 is a perspective view of the gripping mechanism of FIG. 43 being manually withdrawn from the lower mold component of FIG. 39 after suspension of an object in the shape of a snowflake partially within a partially cured lower portion of a gaming die being molded.

FIG. 48 is a perspective view in close up of the object suspended partially within the curing material in the cavity of the lower mold component.

FIG. 49 is a perspective view after coupling of the upper mold component and lower mold component, whereupon the cavity of the upper mold component is filled and the material cured to fully form the item being molded.

FIG. 50 is a perspective view of the resulting molded item.

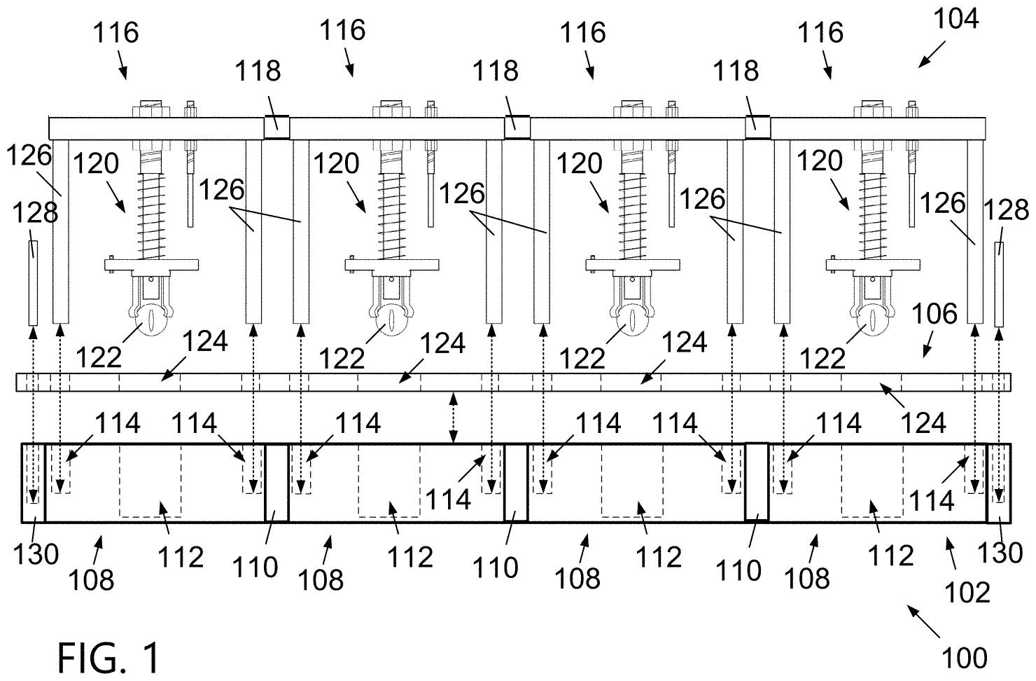

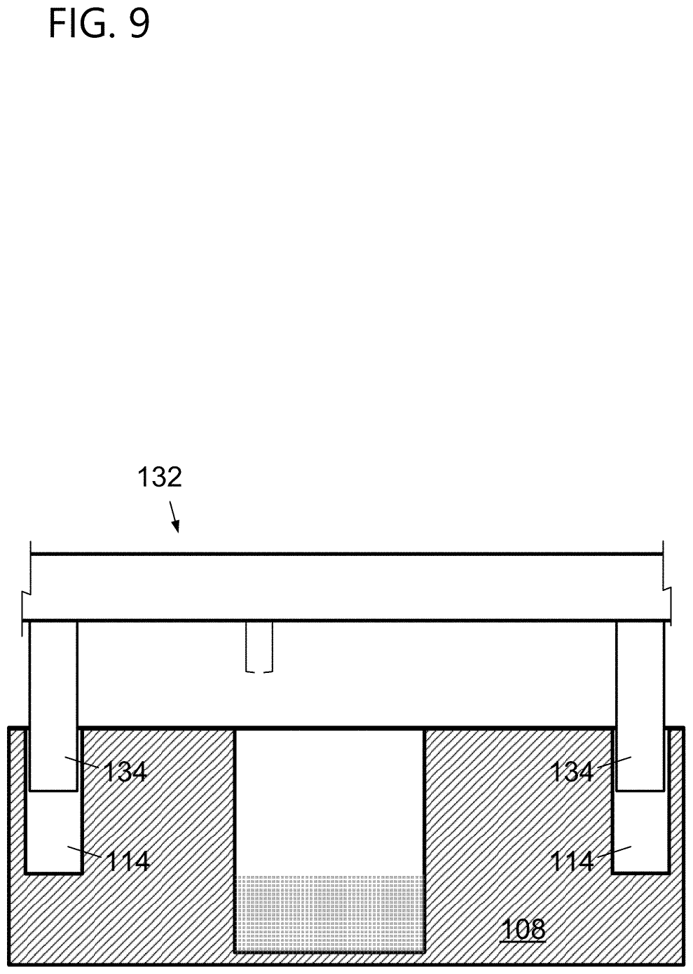

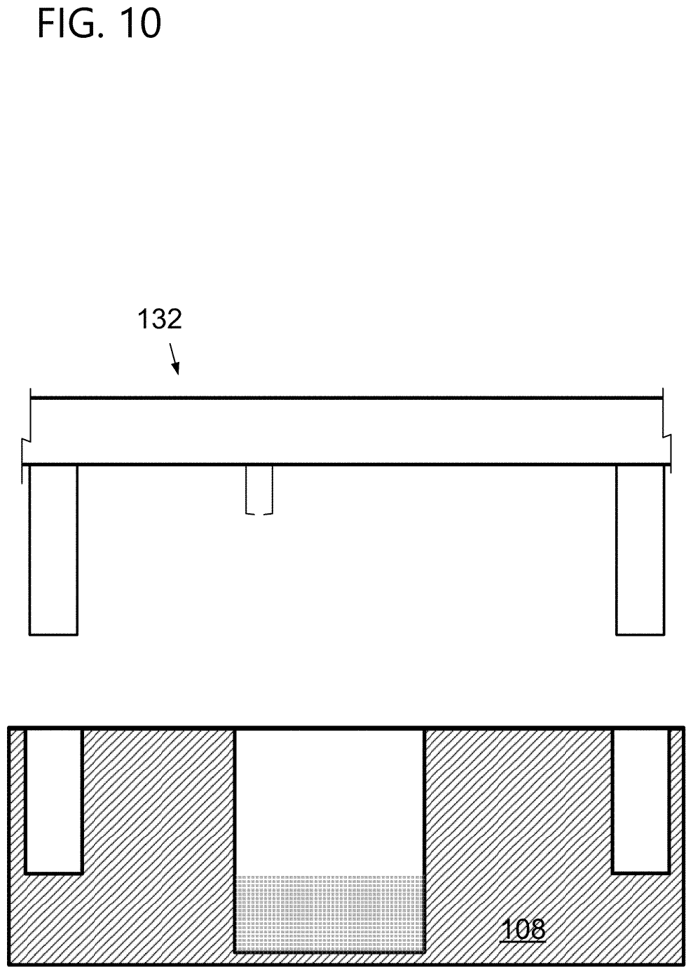

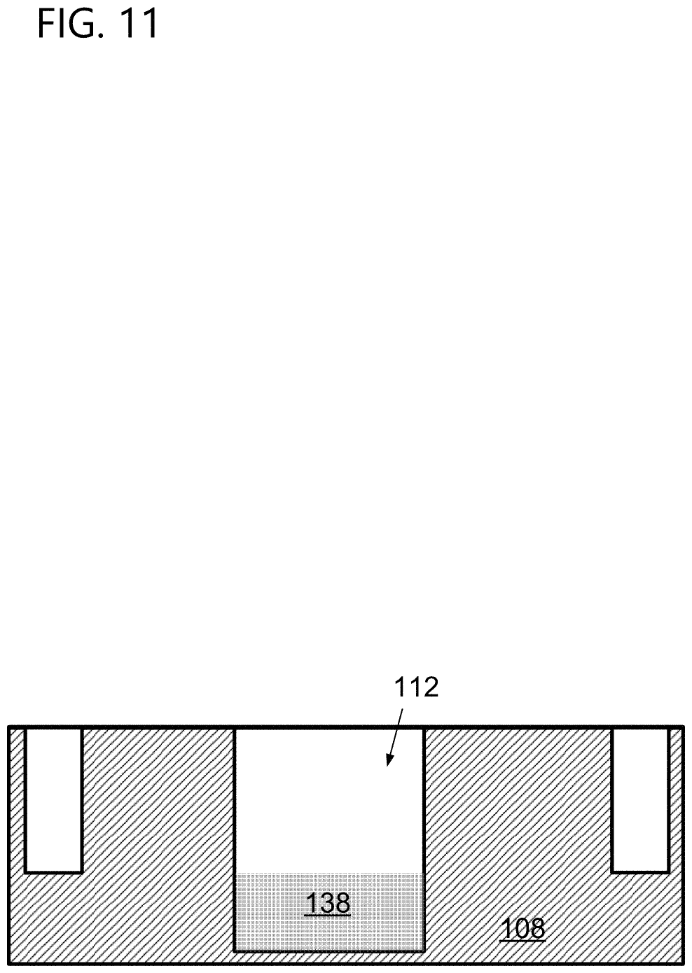

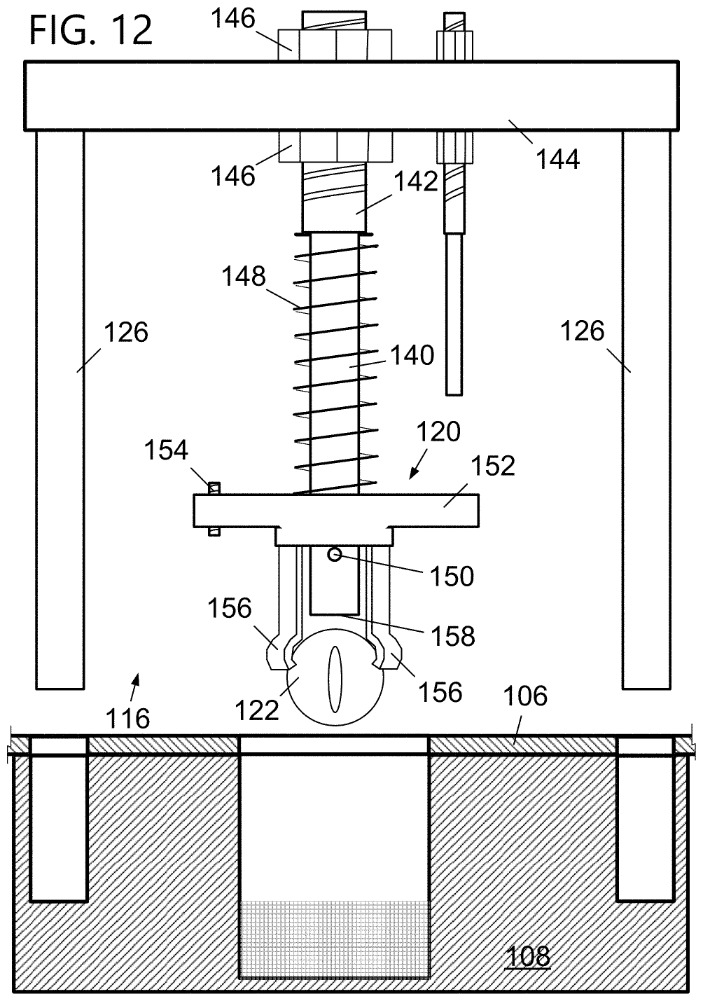

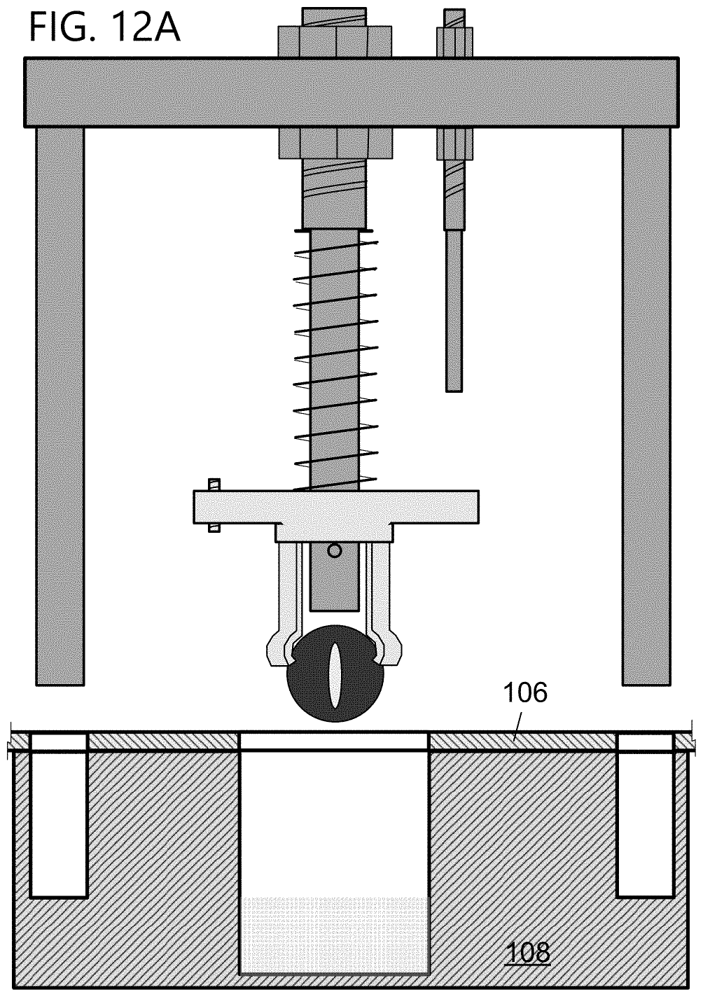

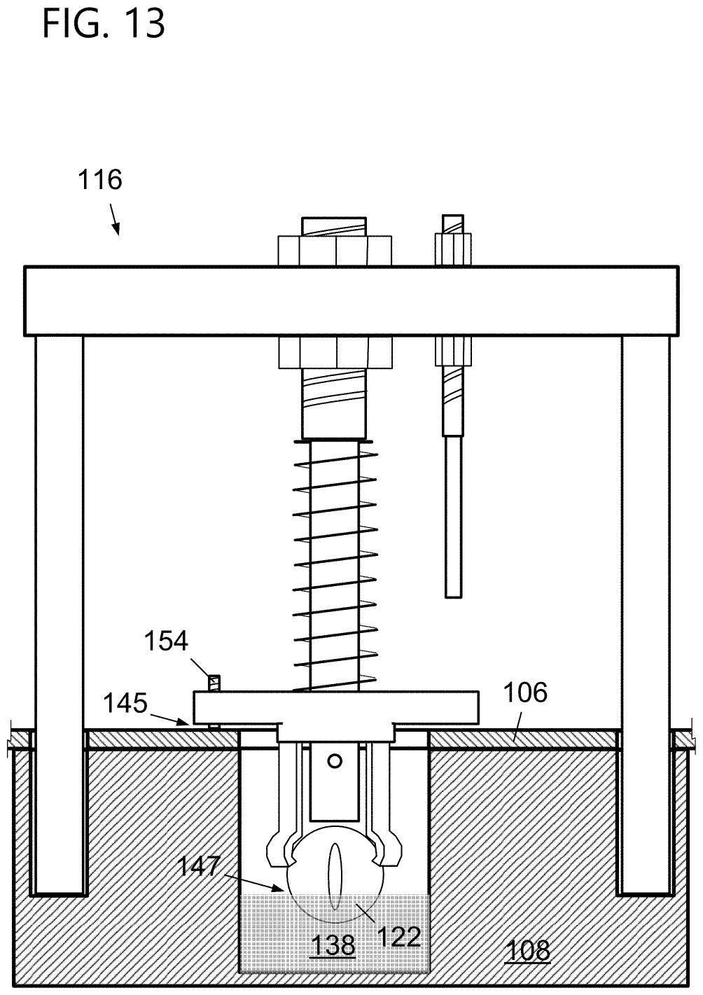

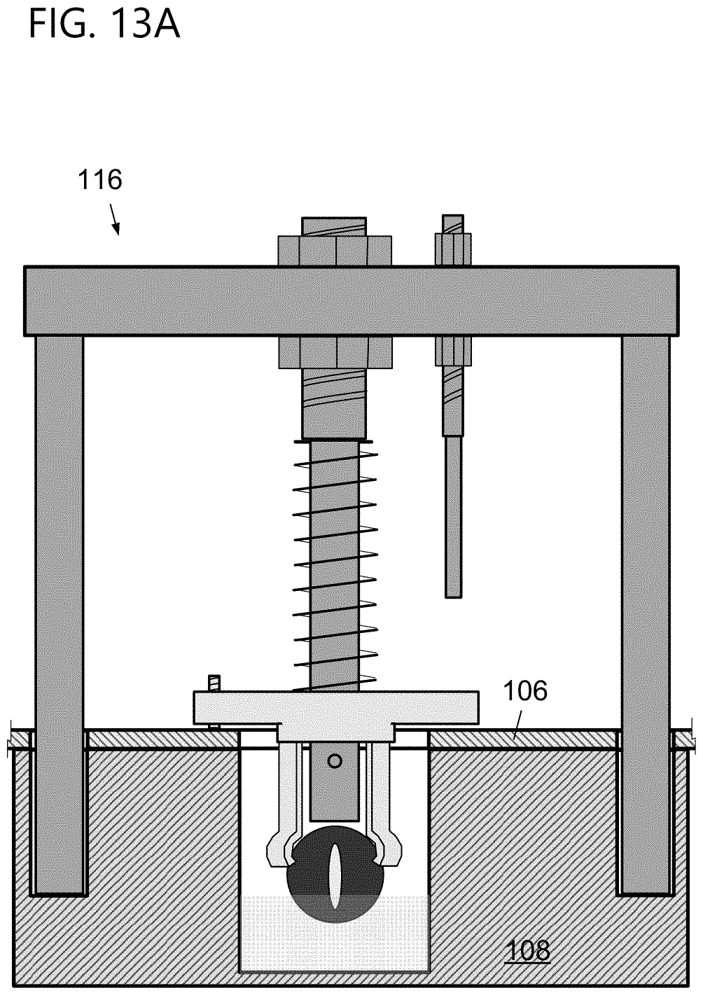

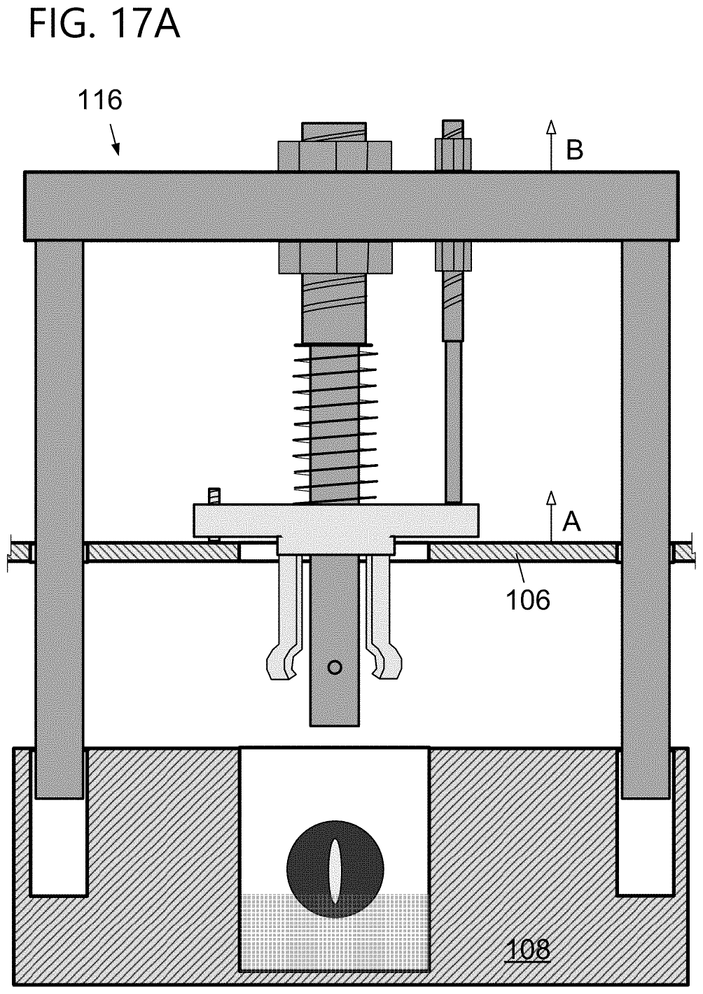

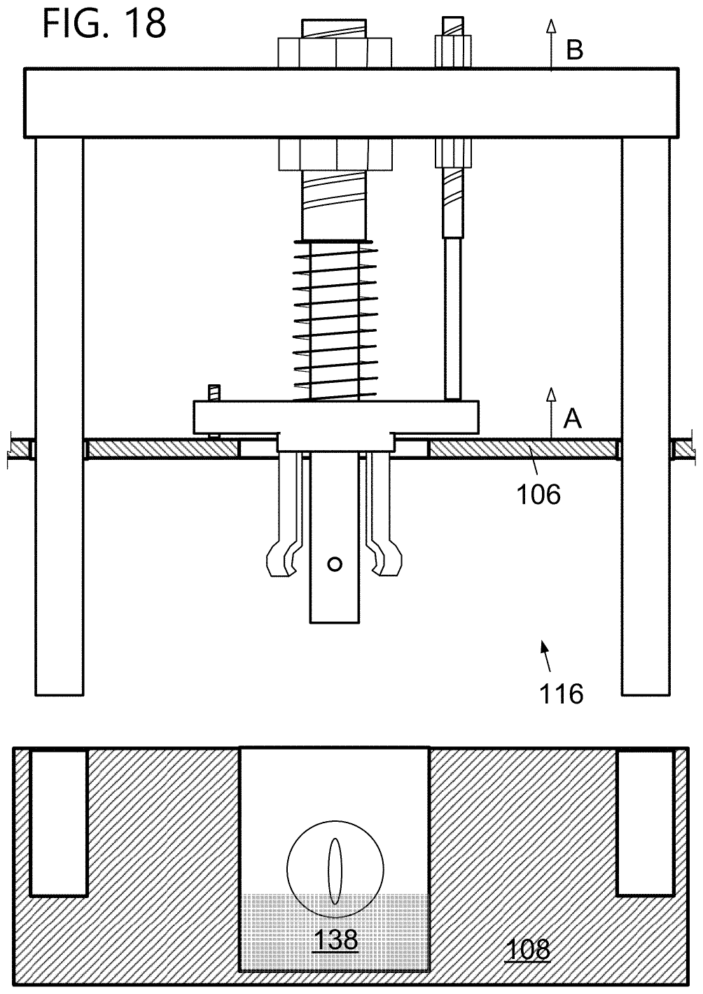

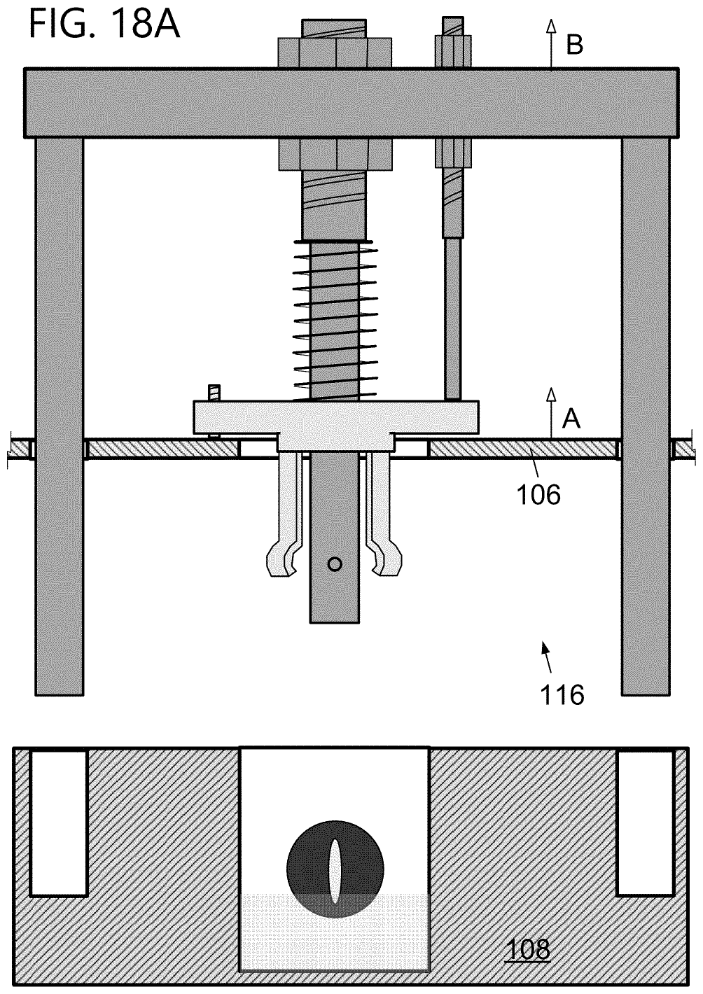

Additionally, FIG. 1A is a shaded view of FIG. 1; FIG. 12A is a shaded view of FIG. 12; FIG. 13A is a shaded view of FIG. 13; FIG. 14A is a shaded view of FIG. 14; FIG. 15A is a shaded view of FIG. 15; FIG. 16A is a shaded view of FIG. 16; FIG. 17A is a shaded view of FIG. 17; FIG. 18A is a shaded view of FIG. 18; FIG. 28A is a shaded view of FIG. 30; FIG. 29A is a shaded view of FIG. 30; and FIG. 30A is a shaded view of FIG. 30.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Additionally, “casting” as used herein and depending on context either refers to a manufacturing process in which a liquid material (e.g., a resin) is usually poured into a mold, which contains a hollow cavity of the desired shape, and then allowed to solidify; or, to the solidified part is also known as a casting, which is ejected or broken out of the mold to complete the process.

Referring now to the drawings, one or more preferred embodiments of the invention are next described. The following description of one or more preferred embodiments is merely exemplary in nature and is in no way intended to limit the invention, its implementations, or uses.

Furthermore, with regard to the following discussion and for clarity of illustration, FIG. 1A is a shaded view of FIG. 1; FIG. 12A is a shaded view of FIG. 12; FIG. 13A is a shaded view of FIG. 13; FIG. 14A is a shaded view of FIG. 14; FIG. 15A is a shaded view of FIG. 15; FIG. 16A is a shaded view of FIG. 16; FIG. 17A is a shaded view of FIG. 17; FIG. 18A is a shaded view of FIG. 18; and FIG. 28A, FIG. 29A, and FIG. 30A are shaded views respectively of FIGS. 28, 29, and 30.

Turning now to the drawings, FIG. 1 is an elevational side view of an embodiment of the invention in the form of an apparatus 100 in accordance with one or more aspects and features. The apparatus 100 is for embedding objects in castings made in batch and comprises a base 102; a framework 104; and a lifting mechanism 106.

The base 102 comprises a plurality of single-cavity molds 108 interconnected by members 110 to form the base. Alternatively, the base may comprise a single, multi-cavity mold without interconnecting members; however, by including a matrix of single-cavity molds connected together, the number of molds—including the number of molds per row and the number of molds per column—may be adjusted as needed or desired for making batches in a needed or desired number at a time. The base further may comprise a plurality of multi-cavity molds connected together in a desired number of molds per row and a desired number of molds per column; and may comprise a plurality of multi-cavity molds and single-cavity molds connected together in a desired number of molds per row and a desired number of molds per column. Moreover, while apparatus 100 includes members 110 for interconnecting the molds 108, the molds themselves may be configured to interconnect together without additional members.

In any scenario, each mold includes at least one cavity, which cavity corresponds to an item to be molded. In the apparatus 100, each mold 108 includes cavity 112. Each mold 108 further includes holes 114, to be described below.

The framework 104 comprises a plurality of individual object positioning members 116 interconnected by members 118 to form the framework 104. Alternatively, the framework may comprise a single integral piece—such as a single plate—with a plurality of object positioning members and without interconnecting members; however, by including a rectangular matrix of object positioning members each connected together, the number of object positioning members—including the number of object positioning members per row and the number of object positioning members per column—may be adjusted as needed or desired for making batches in a needed or desired number at a time, with the matrix of object positioning members corresponding to an associated matrix of molds of the particular apparatus. The framework further may comprise a plurality of plates—each with a plurality of object positioning members—that are connected together in a desired number per row and a desired number per column; and may comprise a plurality of plates each with one or more object positioning members connected together in a desired number per row and a desired number per column. Moreover, while apparatus 100 includes members 118 for interconnecting the object positioning members 116, the object positioning members themselves may be configured to connect together without additional interconnecting members.

In any scenario, each object-positioning member 116 is configured to suspend an object from the framework into a cavity of a mold for embedding the object within the molded item. In particular, each object positioning member 116 comprises a gripping mechanism 120 that suspends an object—such as an eyeball 122 resembling the “Eye of Sauron” or “Great Eye” from the Lord of the Rings® trilogy. The gripping mechanism 120 is configured to release the suspended object upon actuation.

In this respect—and with reference to FIG. 12 which better illustrates in detail an object-positioning member 116, the object-positioning members 116 comprises an ejection pin 140 having a threaded base 142 that is attached and secured to a top plate 144 of the framework 104 by nuts 146 and that is thereby adjustable in its downward extent relative to the top plate 142, which adjustment is independent of such adjustment of other ejection pins of the other object-positioning members 116. The gripping mechanism 120 defines an opening through which the ejection pin 140 extends, and the gripping mechanism 120 slides on the ejection pin 140. A spring 148 is concentrically wrapped around the ejection pin 140 and biases the gripping mechanism 120 downwardly away from the top plate 142 and a shoulder 152 of the gripping mechanism 120 into abutting engagement with a limiting pin 150 that protrudes from the ejection pin 140 and that limits downward movement of the gripping mechanism on the ejection pin 140.

A set screw 154 is received within a threaded hole of the shoulder 152 and is adjustable for adjusting the distance at which the shoulder 152 rests relative to the lifting mechanism 106 when the framework 104 is properly aligned and set on top of the base 102. The eyeball 122 is gripped by elongate gripping arms 156 that extend downwardly from the shoulder 152 and that are tensioned in their grasp of the eyeball 122. The arms 156 hold the eyeball at a location close to, i.e., proximate, an end 158 of the ejection pin 140. The eyeball 122 preferably is manually inserted or “popped” into gripping engagement with the gripping arms 156 and manually arranged into a desired orientation for embedding within the object to be molded. The gripping arms 156 preferably are contoured to grasp whatever object is to be embedded and two or more gripping arms may be utilized in the gripping mechanism 120, as desired or needed. As perhaps best seen in contrasting the views of FIG. 15 and FIG. 16, the end 158 of the ejection pin 140 engages and pushes the eyeball out of the grasp of the gripping arms 156 as the gripping mechanism is lifted upward along ejection pin 140 toward the top plate 142. When so retracted, the eyeball 122 is blocked from traveling with the gripping mechanism 120 in its retraction, whereby the gripping arms 156 lose their grip of the eyeball 122. It will be appreciated that the gripping mechanism is spring biased against retraction and, thus, the object, e.g., the eyeball 122, will not be released except for when the lifting mechanism 106 is lifted, raised, or otherwise moved toward the top of the framework 104 and away from the base 102.

Return to FIG. 1, the lifting mechanism 106 is transitionable for effecting actuation of the plurality of gripping mechanisms 120 such that the eyeballs 122 suspended by the gripping mechanisms 120 are released generally at the same time. In the apparatus 100, the lifting mechanism 106 preferably comprises a plate that extends between the base 102 and the framework 104 and that includes holes 124. Each hole 124 is dimensioned and arranged to permit the passing of the eyeball 122 and at least a portion of the gripping mechanism 120 therethrough and into a respective cavity 112, as described below.

In order for the framework 104 to be properly set on top of the base 102 with the lifting mechanism 106 extending therebetween, the framework includes pillars 126 that extend downwardly from the plate 126, through holes 124 in the lifting mechanism 106, and into the holes 114 in the base 102. The pillars 126 maintain the top of the framework 104 in a fixed disposition relative to the base 102 when the framework is properly seated on the base 102. Furthermore, the lifting mechanism 106 is configured to be lifted up from the based 102 with the pillars 126 extending through the holes 124; in other words, the pillars 126 are configured to slide relative to the lifting mechanism 106 within the holes 124.

To properly align the lifting mechanism 106 when seated on top of the base 102, especially when the framework 104 is not seated on top of the base 102, preferably alignment rods 128 extend through alignment holes in the lifting mechanism 106 and into holes in members 130 of the base 104. This permits the lifting mechanism 106 to be placed first on top of the base 102 in proper orientation prior to placement of the framework 104, as well as permits the framework 104 to be removed from the base 102 if needed while maintaining alignment of the lifting mechanism 106 relative to the base 102. The members 130 may be interconnecting members or simply members that attach to one or more molds of the base along a periphery of the base 102, as illustrated in FIG. 1.

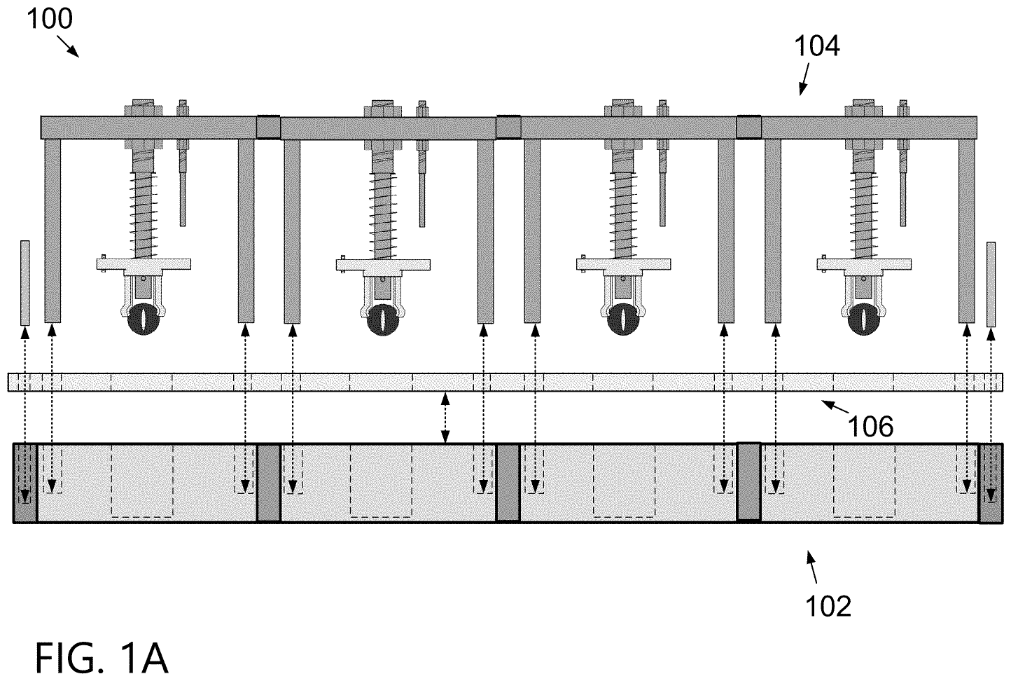

FIG. 2 is an elevational view of one of the single-cavity molds 108 used in the embodiment of FIG. 1.

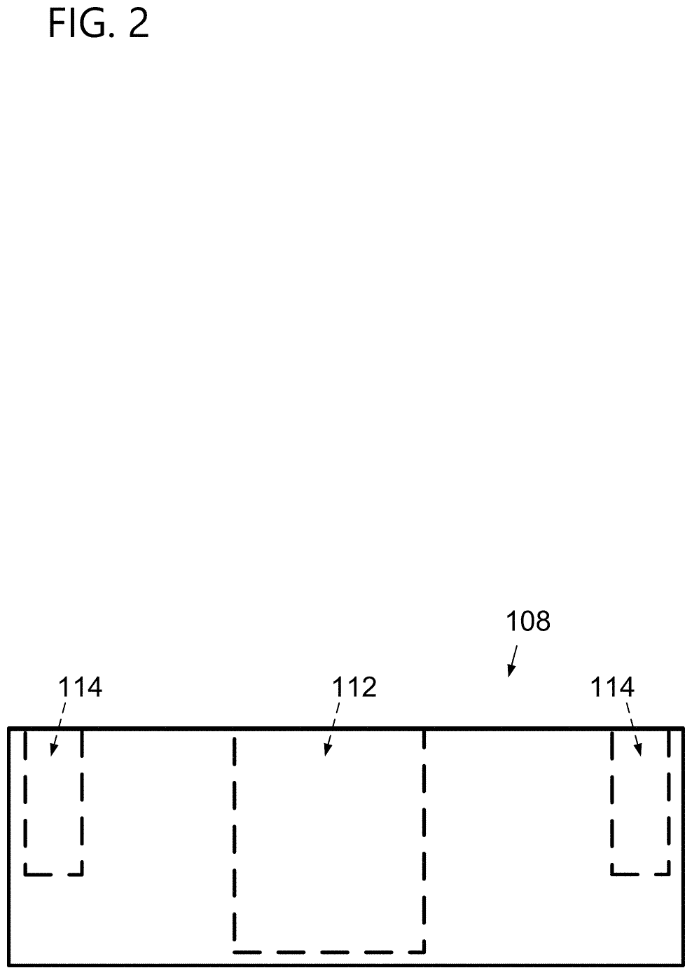

FIG. 3 is an elevational view of the single-cavity mold 108 and a filling apparatus 132. Similar to the framework 104, the filling apparatus 132 includes pillars 134 that extend within holes 114 of the base for proper alignment and seating of the filling apparatus onto the top of the base 102. Similar to the lifting mechanism 106, the filling apparatus 132 preferably extends across and covers the top of the base 102. The filling apparatus 132 includes a plurality of nozzles 134, one of which is illustrated in FIG. 3; each nozzle corresponds to a cavity 112 to be filled with a liquid using the filling apparatus 132. Moreover, each cavity 112 of the base 102 preferably is partially filled with the liquid at the same time.

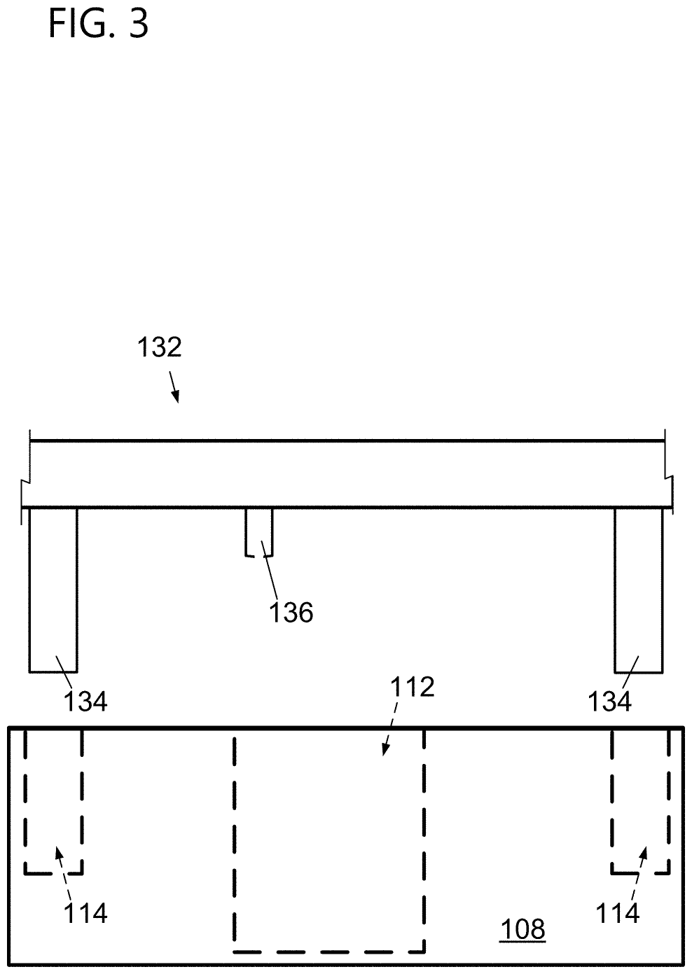

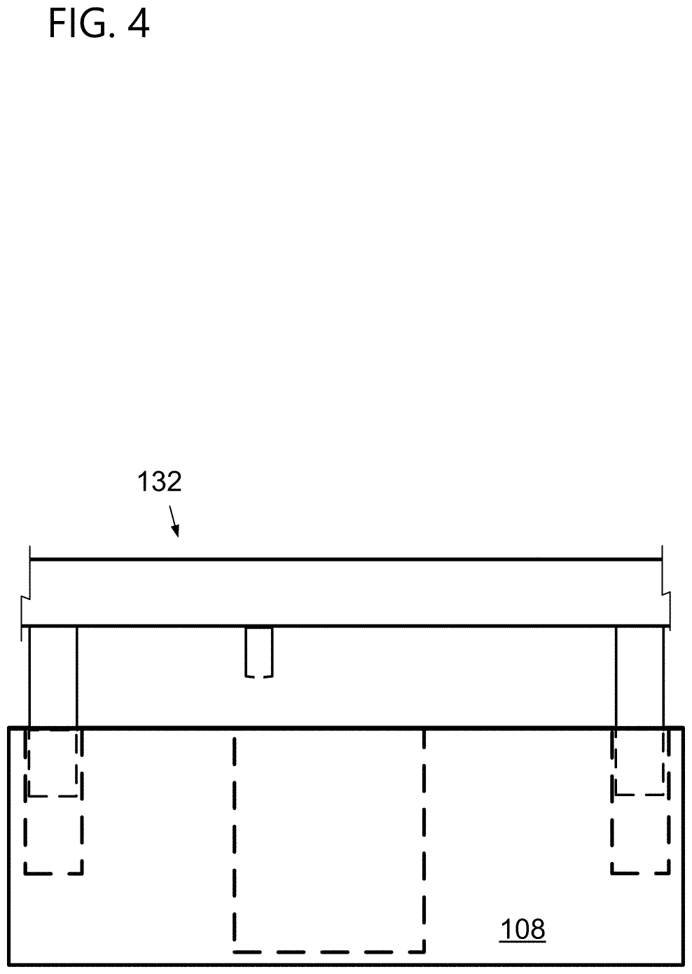

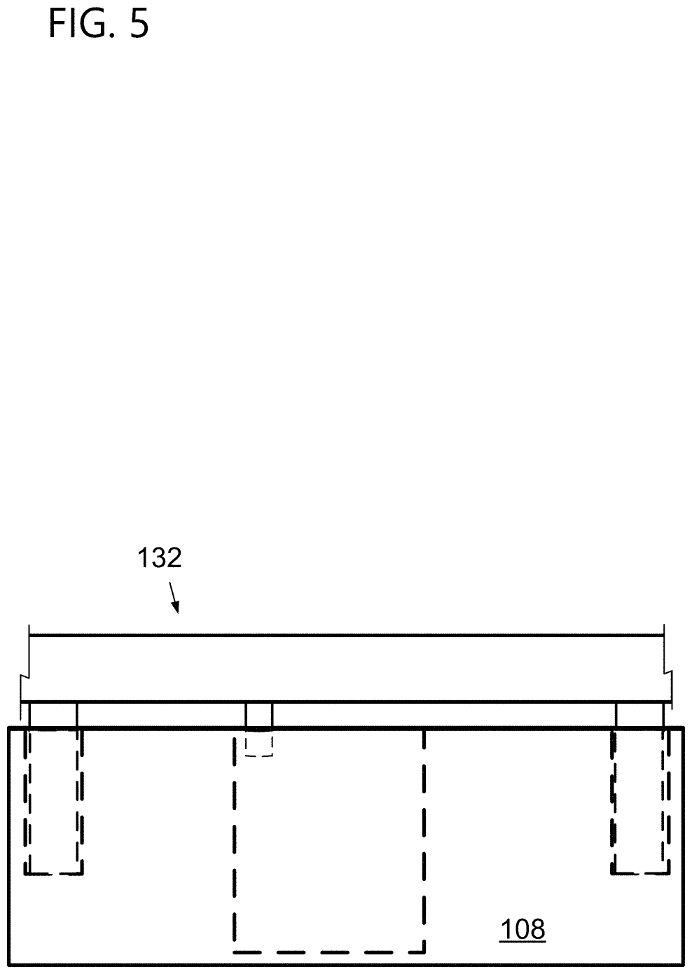

In particular, FIG. 4 is an elevational view of the filling apparatus 132 being placed on top of and in alignment with the single-cavity mold 108; FIG. 5 is an elevational view of the filling apparatus 132 properly placed on top of and aligned with the single-cavity mold 108; and FIGS. 6-8 are elevational views of the cavity 112—now shown in cross-sectional view—being filled with a liquid 138 using the filling apparatus 132. The cavity 112 is only partially filled, as seen in FIG. 8. Of course, it will be appreciated that while the filling of the cavity is illustrated as being performed from the top of the cavity, the filling may be accomplished by filling the cavity from a side or bottom opening in the cavity, if required or otherwise desired.

The liquid 138 hardens into a body having the shape of the cavity 112 of the mold 108 to form the body of the molded item. The liquid 138 may comprise a resin such as those resins used to make transparent dice; however, the liquid 138 may comprise other substances that harden or cure over time or in response to heat, cold, or chemical. It furthermore is contemplated that the liquid may comprise water that is hardened by being frozen.

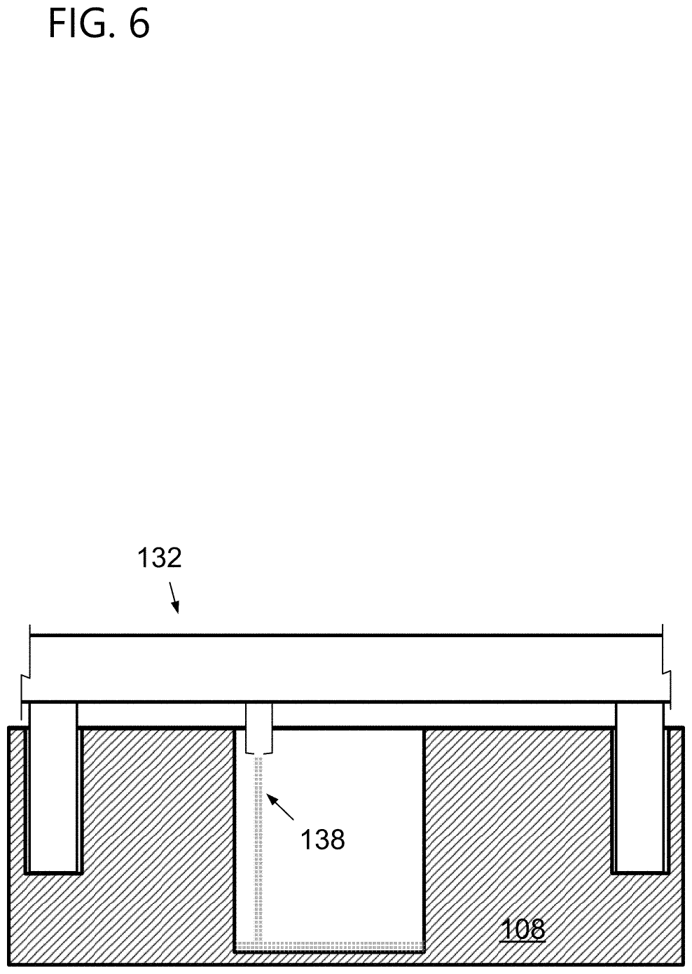

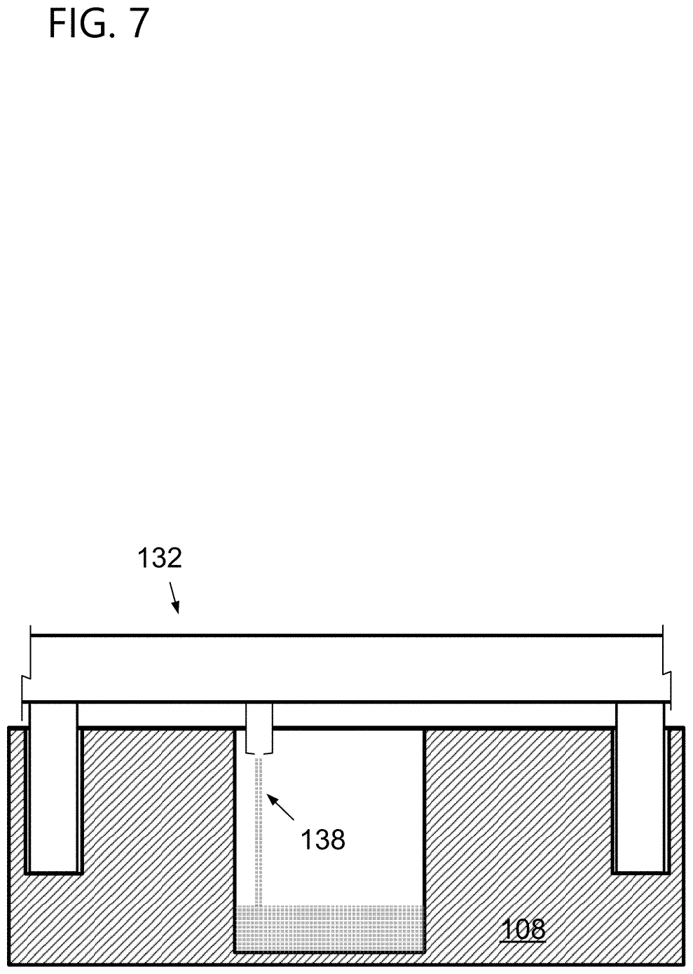

Once the cavity 112 is partially filled, the filling apparatus 132 is removed from the single-cavity mold 108. FIG. 9 is an elevational view of the lifting upward of the filling apparatus 132 from the mold 108 and withdrawal of the pillars 134 from the holes 114 of the sing-cavity mold 108; and FIG. 10 is an elevational view of the filling apparatus 132 once again separate from the single-cavity mold 108.

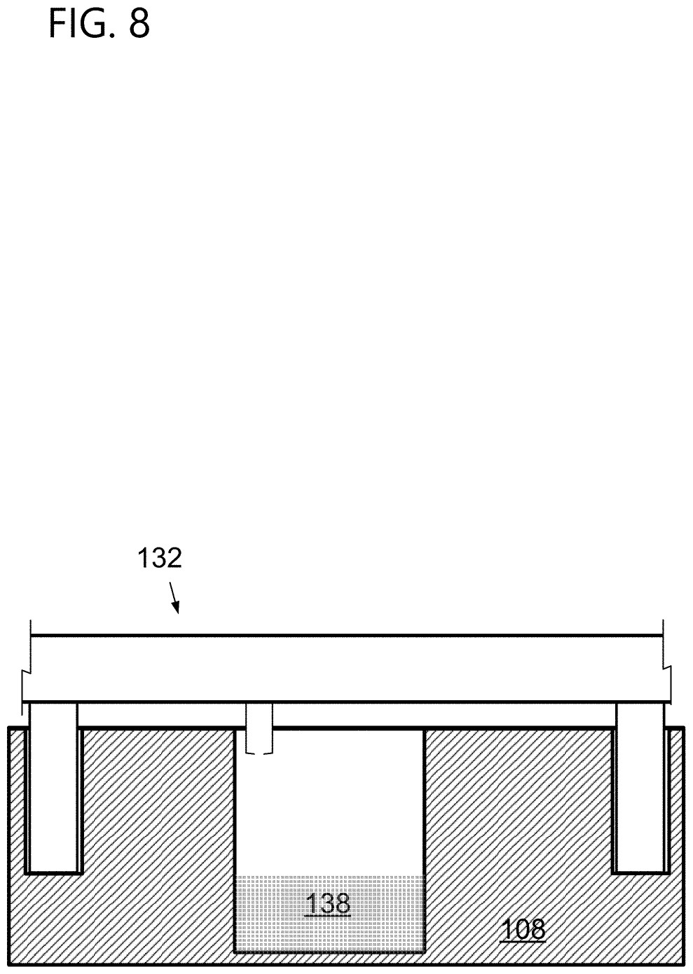

FIG. 11 is an elevational view of the resulting single-cavity mold 108 with the cavity 112 having been partially filled with the liquid 138.

FIG. 12 is an elevational view of the single-cavity mold 108 and, additionally, an object-positioning member 116 and a lifting mechanism 106—shown in cross-section, all of which are used in the apparatus 100 of FIG. 1.

FIG. 13 is an elevational view of the object-positioning member 116 having been properly seated on top of the single-cavity mold 108 with the lifting mechanism 106 extending in-between a top of the object-positioning member 116 and the single-cavity mold 108. As seen at 145, the set screw engages the top of the lifting mechanism 106 as the object positioning member 116 is lowered onto the base 102. The set screw is configured (i.e., set) such that the eyeball 122 is sunk into the liquid 138 as seen at 147. The depth to which the eyeball 122 is sunk into the liquid 138 corresponds to the desired positioning of the eyeball 122 relative to the bottom of the cavity 112 that defines the shape of the item being molded.

FIG. 14 is an elevational view similar to that of FIG. 13, wherein the lifting mechanism 106 has been lifted slightly as indicated by arrow A to the point where the ejection pin 140 of the object-positioning member 116 engages the eyeball 122 that is grasped and suspended by the gripping arms 156.

FIG. 15 is an elevational view similar to that of FIG. 14, wherein the eyeball 122 is seen as having been released from the gripping arms 156 as the lifting mechanism is further lifted as indicated by arrow A.

The lifting mechanism 106 is not lifted until the liquid 138 has at least partially hardened and is sufficient to retain the eyeball 122 in its position and orientation once the gripping arms release the eyeball 122. Time permitting, the transition of the lifting mechanism 106 from the position shown in FIG. 13 to the position shown in FIG. 14 preferably is sufficient for the liquid 138 to harden to a state in which the eyeball 122 is actually held in place by the hardened liquid 138 and the eyeball 122 does not lift into engagement with the ejection pin 140 and, instead, is released by the gripping arms 156 before such engagement due to the retention of the eyeball 122 by the hardened liquid 138.

FIG. 16 is an elevational view similar to that of FIG. 15, wherein the gripping mechanism 120 has been lifted to the point where it is engaged by a downwardly extending stop 160 of the object-positioning member 116 and is thereby precluded from further retraction relative to the top plate 144 of the framework 104 of the object-positioning member 116. Specifically, the stop 160 comprises a threaded base 162 that is attached and secured to the top plate 144 by nuts 164 whereby the downward extent of the stop 160 is adjustable relative to the top plate 144. The bottom of the stop 160 engages at 147 the shoulder 152 of the gripping mechanism 120 and stops further lifting of the gripping mechanism 120.

FIG. 17 is an elevational view similar to that of FIG. 16 illustrating that further lifting of the lifting mechanism 106 as indicated by arrow B then results in lifting of the object-positioning member 116 (and the framework 104) up from the base 102.

FIG. 18 is an elevational view similar to that of FIG. 17 illustrating that further lifting of the lifting mechanism 106 results in the separation of the object-positioning member 116 and each mold 108 of the base 102.

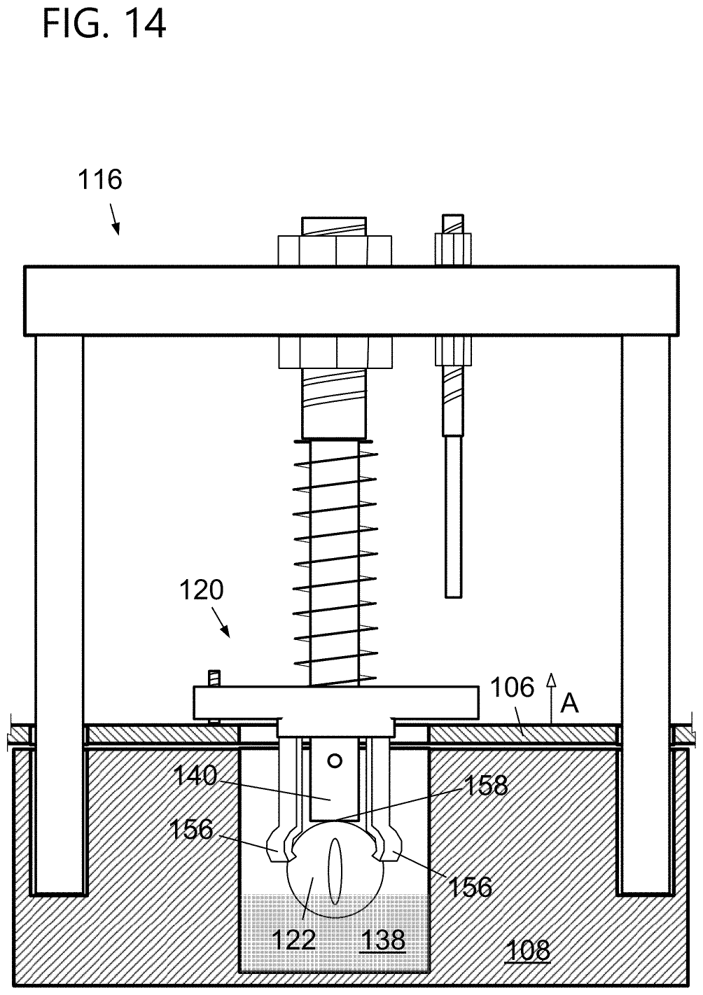

FIG. 19 is an elevational view of the resulting single-cavity mold 108 with the cavity 112 having been partially filled with the liquid 138 with the eyeball 122 being correctly positioned within the cavity, the eyeball having been partially sunk within the liquid and the liquid having at least partially hardened so as to retain the eyeball in the desired position and orientation.

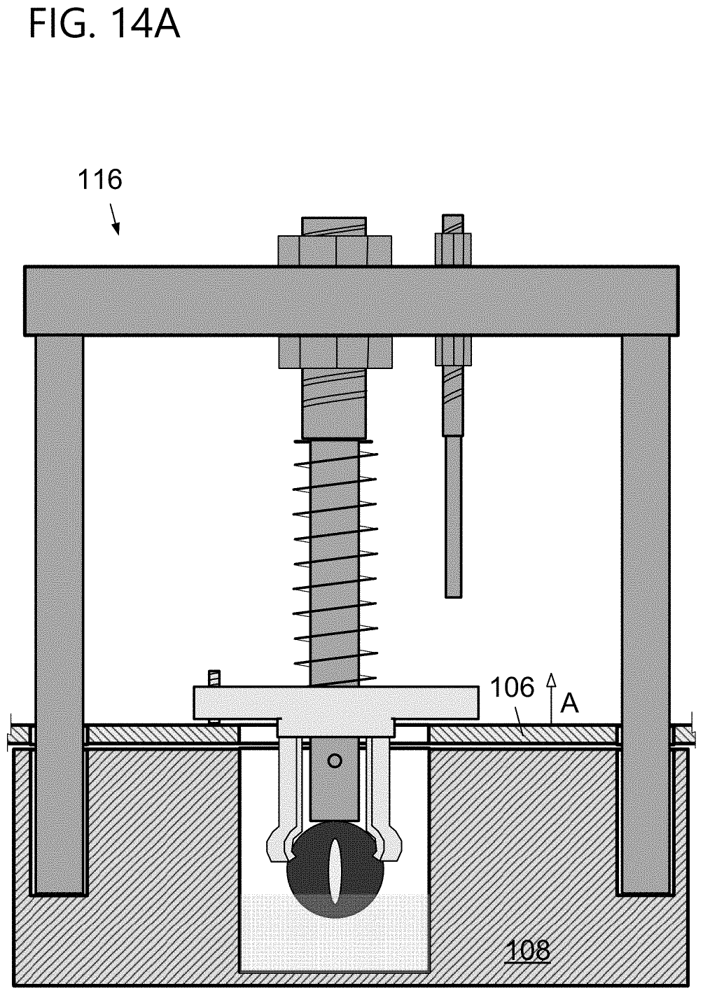

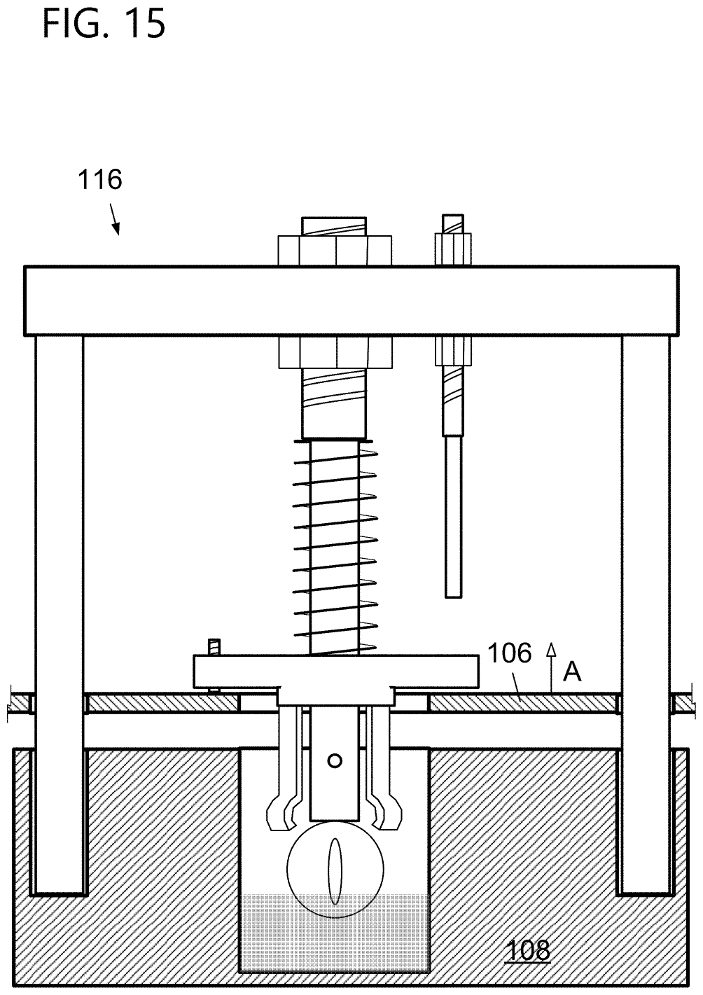

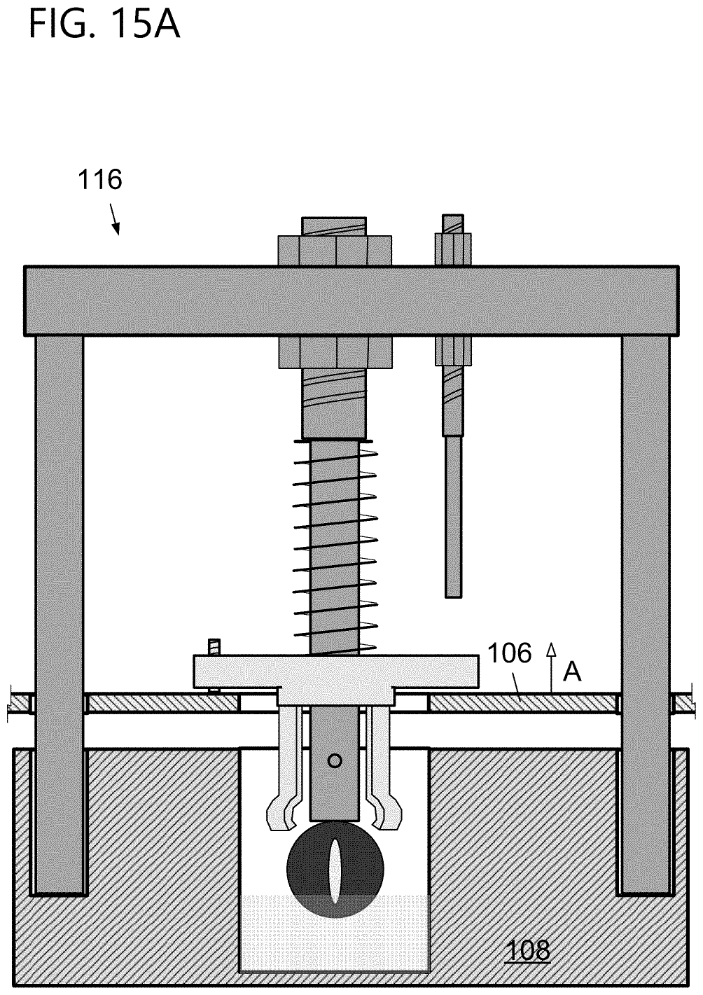

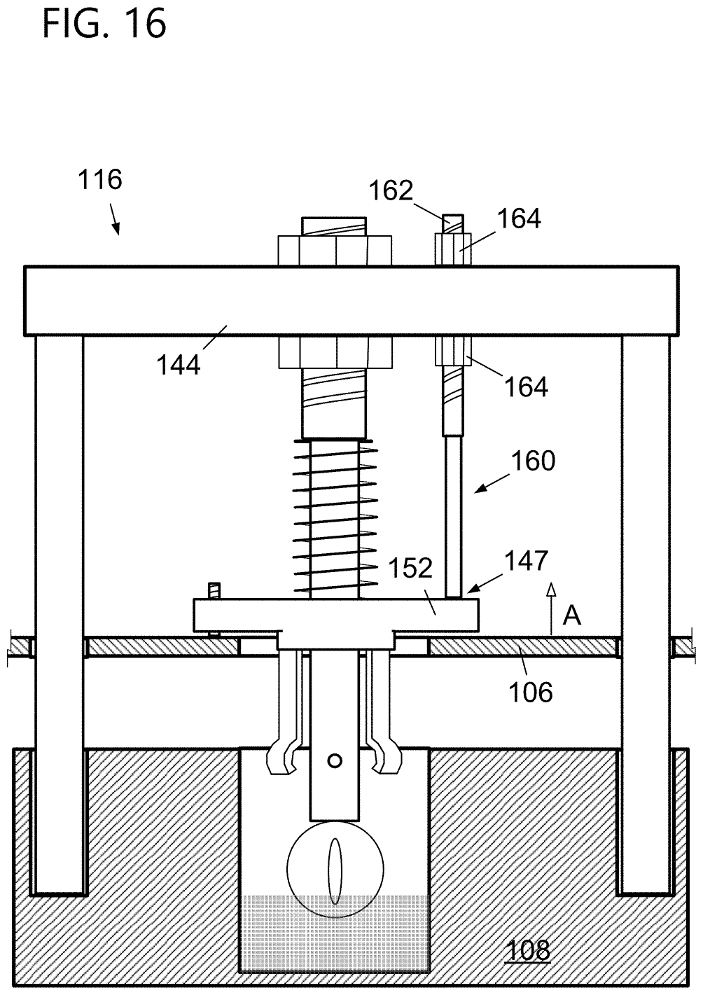

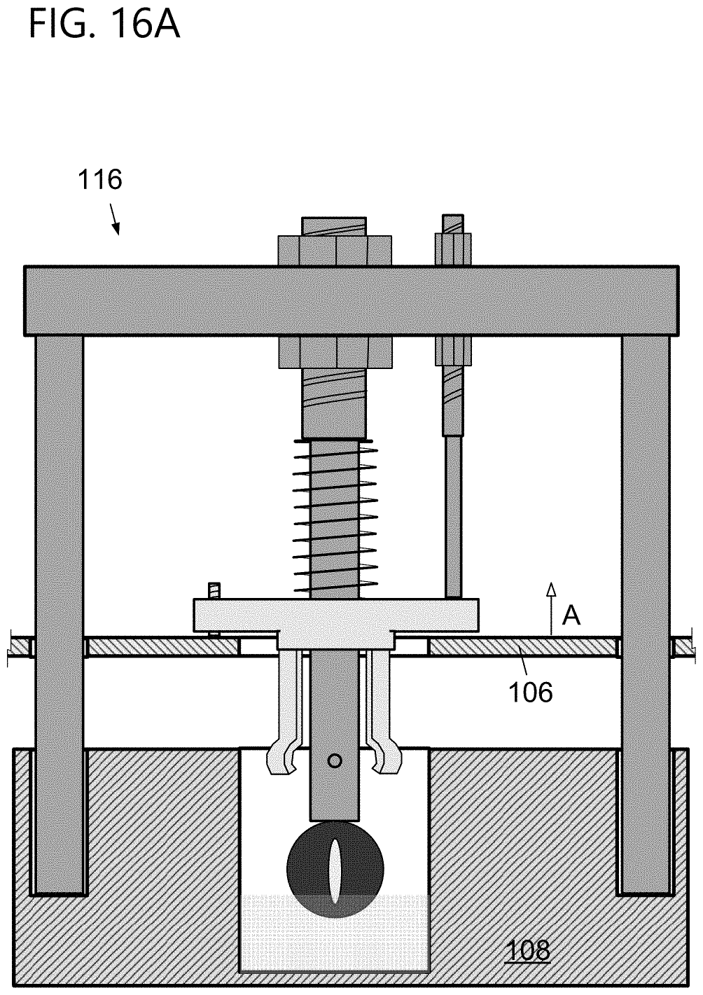

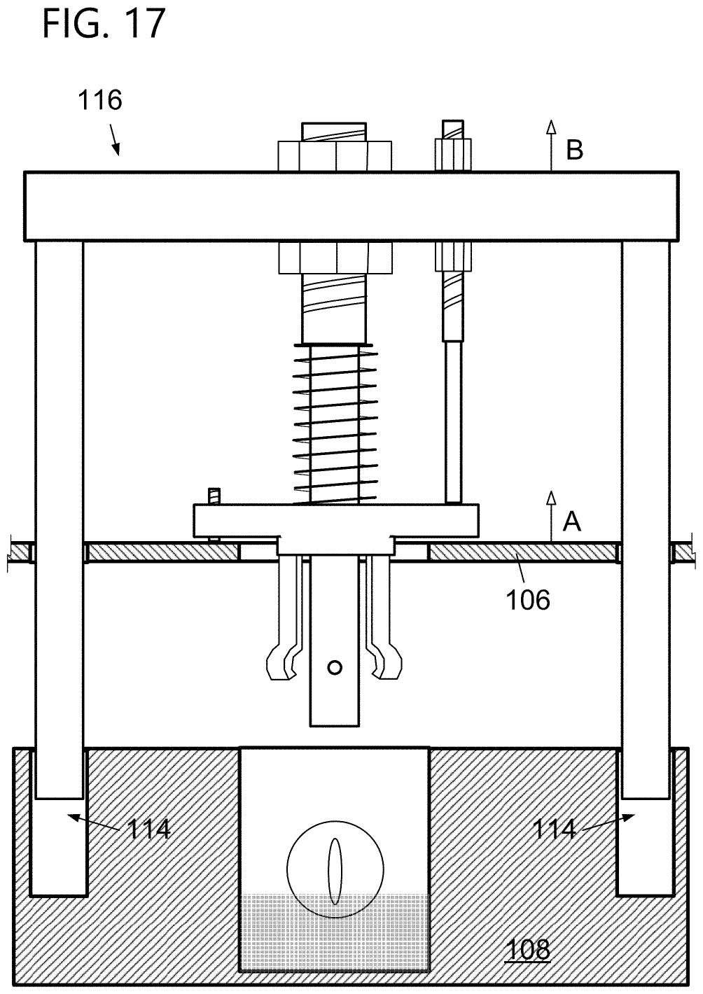

To complete the molding process, the cavity must be filled with the remainder of the liquid needed for molding the item with the object embedded inside it. FIGS. 20-27 illustrate this process. In particular, FIG. 20 is an elevational view of the single-cavity mold 108 and the filling apparatus 132. FIG. 21 is an elevational view of the filling apparatus 132 being placed on top of and in alignment with the single-cavity mold 108; and FIG. 22 is an elevational view of the filling apparatus 132 properly placed on top of and aligned with the single-cavity mold 108. FIGS. 23-25 include the elevational view of FIG. 22 and collectively illustrate the continued filling of the cavity 112 of the single-cavity mold 108. FIG. 26 shows the filling apparatus 132 being removed from the single-cavity mold 108 with the eyeball 122 having been fully immersed in the liquid within the cavity; and FIG. 27 shows the filling apparatus 132 separated from the single-cavity mold 108.

FIG. 28 shows the resulting molded item 170 having been removed from the single-cavity mold 108 after hardening of the liquid 138. Once hardened, the liquid 138 preferably is transparent so that the eyeball 122 embedded therein is viewable, as illustrated in FIG. 29; FIG. 29 is an elevational view similar to that of FIG. 28 once the molded item 170 has been finished and is ready for sale or commercial use. FIG. 30 also illustrates the item 170 and is an isometric view of the finished product, which in this preferred embodiment comprises a six-sided die with the eyeball 122 embedded therein. Importantly, the eyeball is embedded in a desired orientation in which the “1” of the die is aligned with the eyeball 122 to appears as an iris of the eyeball 122, as illustrated in FIG. 29. Such precision in orientation is batch manufacturing of dice is believed to have been henceforth unobtainable prior to embodiments of the invention.

In use of the apparatus 100 and alternative variations thereof in a molding process, the steps of a method comprise: partially filling a plurality of cavities of the multi-cavity mold with a liquid, the plurality of cavities comprising three or more cavities; simultaneously for each cavity that has been partially filled with the liquid, partially sinking an object into the liquid in said cavity; and after at least partially hardening of the liquid partially filled in said cavities with the objects partially sunk therein, fully immersing the objects that have been partially sunk by continuing to fill said cavities with the liquid, whereby upon further hardening a casting is formed in each said cavity having a respective said object embedded therein. Such apparatus and, in particular, the lifting mechanism, preferably is manually operated by hand.

Preferably, the step of partially filling the plurality of cavities is performed simultaneously for each cavity; and the step of fully immersing the objects is performed by simultaneously filling said cavities.

Furthermore, at least a subset of the plurality of said cavities preferably are identical in dimensions and orientation, and the identical objects are partially sunk into the liquid in the cavities of the subset with said identical objects having the same orientation relative to the direction of sinking.

In preferred embodiments, each casting formed in each cavity is a die with a batch of dice being made each time.

Alternatively, for example, a batch of ice cubes are made each time each having an edible object embedded therein.

In order to facilitate each item having an object embedded therein in a particularly desired orientation, the method further comprises positioning the objects in gripping mechanisms suspended from the framework and using the framework to sink the objects within the liquid within the cavities, wherein the identical objects are identically oriented relative to their respective gripping mechanisms.

The liquid preferable comprises a resin. The liquid alternatively may comprise, for example, water or other liquid beverage. The liquid may be hardened by freezing, heating, or using one or more chemicals.

### Prototypes

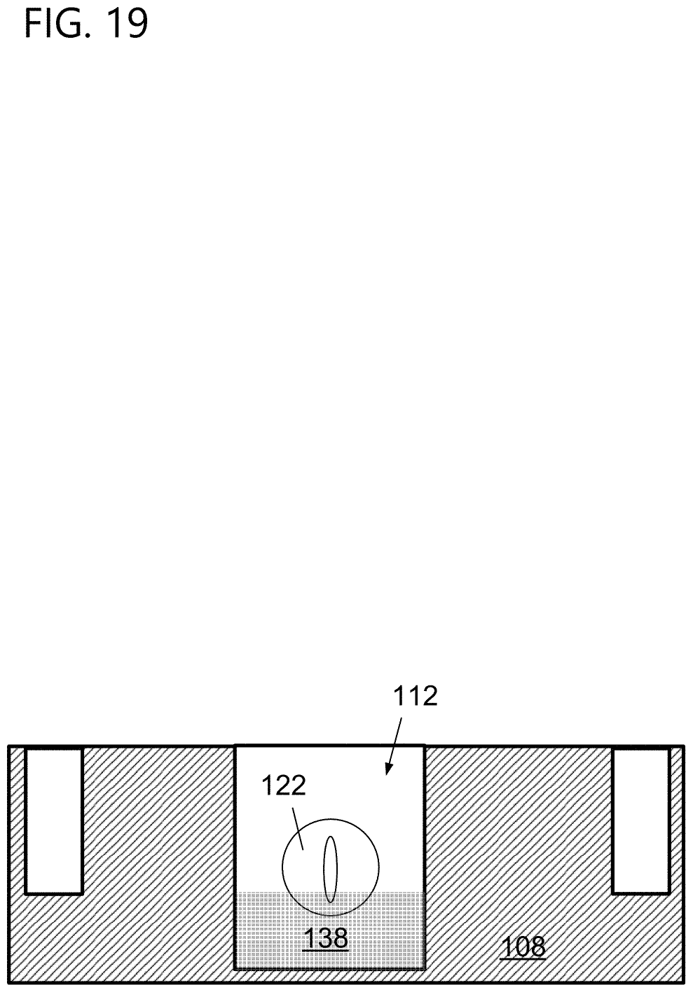

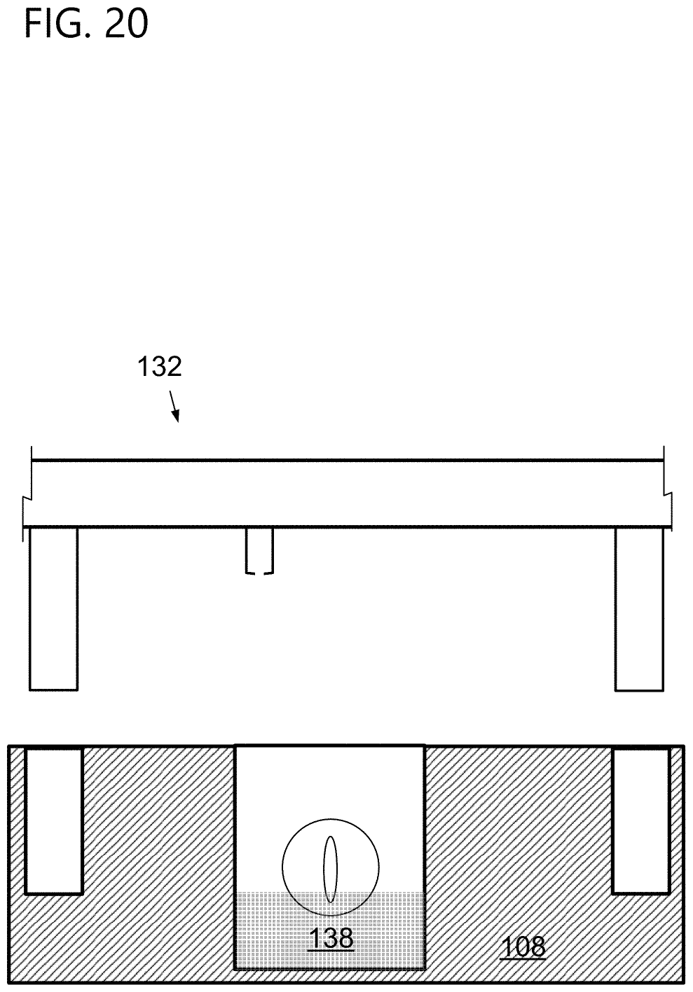

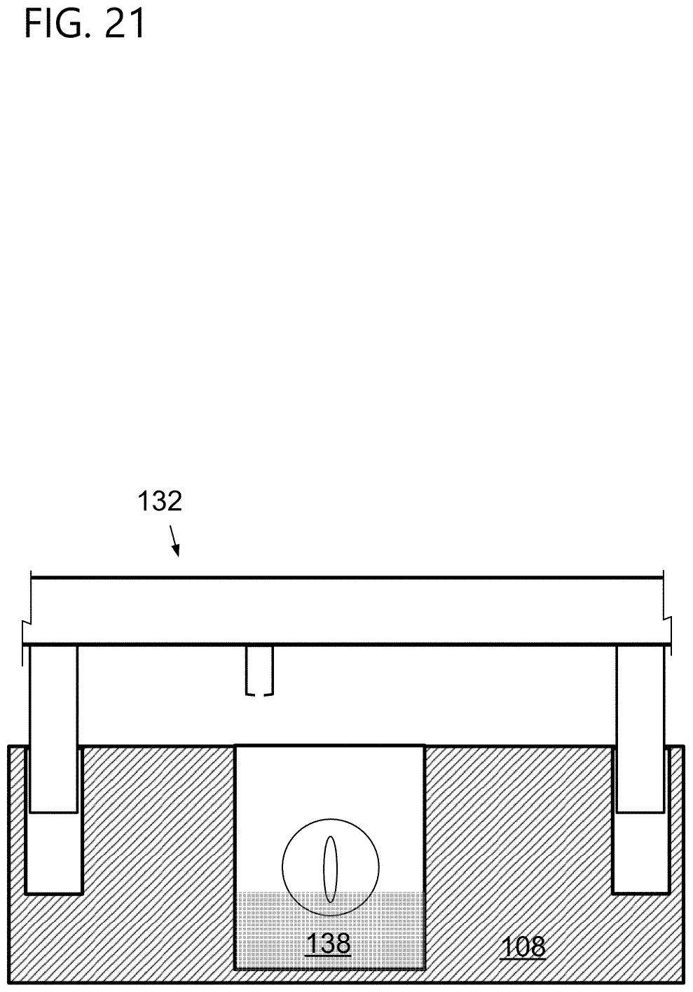

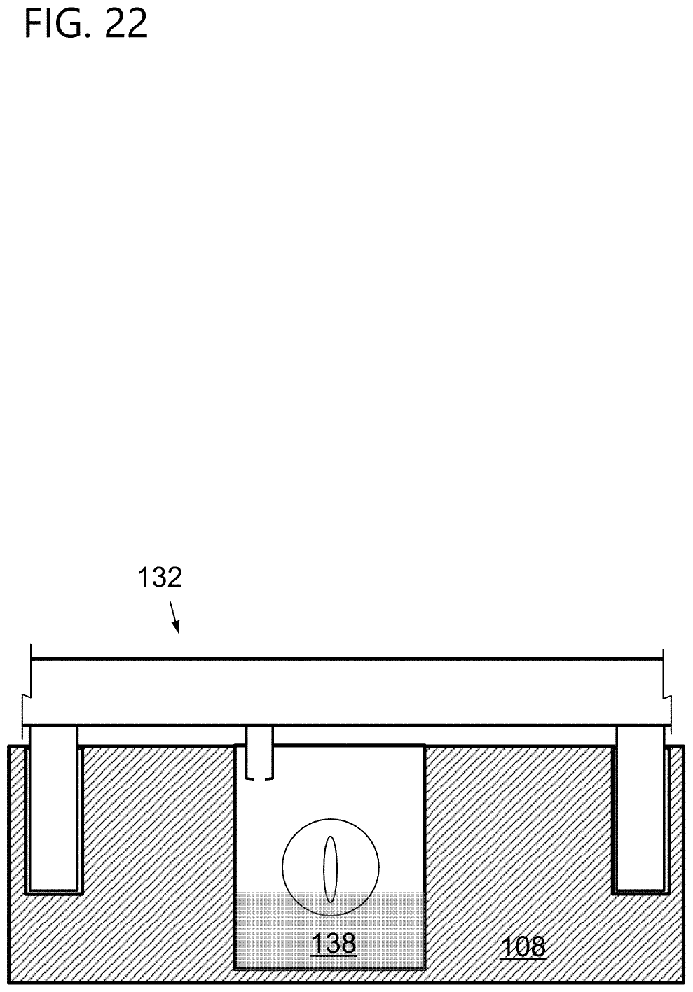

FIG. 31 is a photograph of an elevational view of a prototype gripping mechanism, ejection pin, limiting pin, and spring in accordance with one or more aspects and features of the invention. FIGS. 32, 33, and 34 each is a photograph thereof with an object comprising a plastic eyeball being retained by the gripping arms of the gripping mechanism.

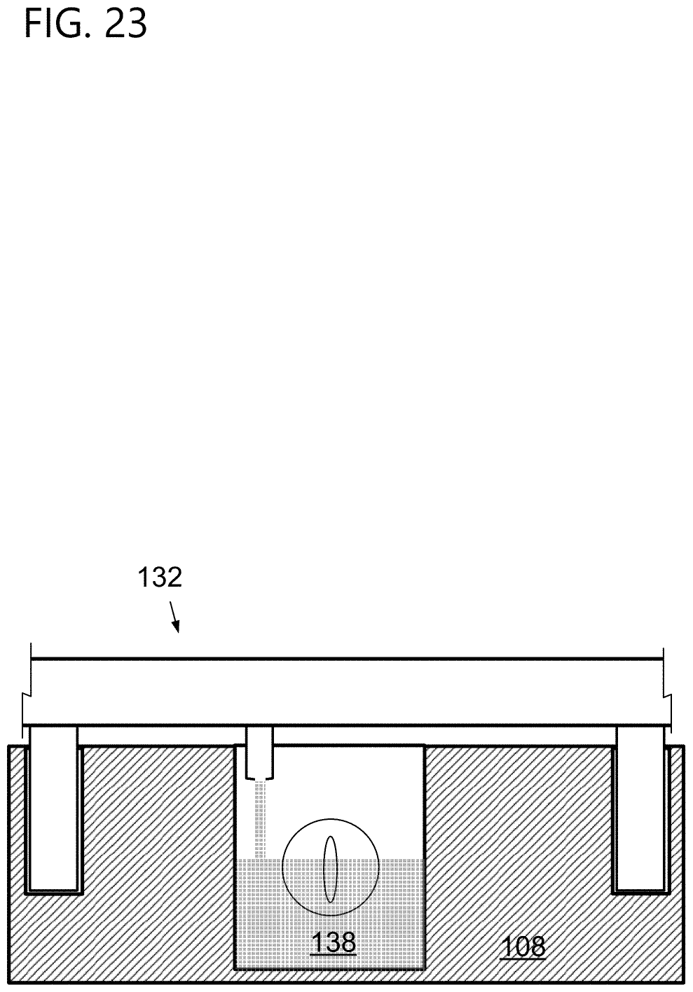

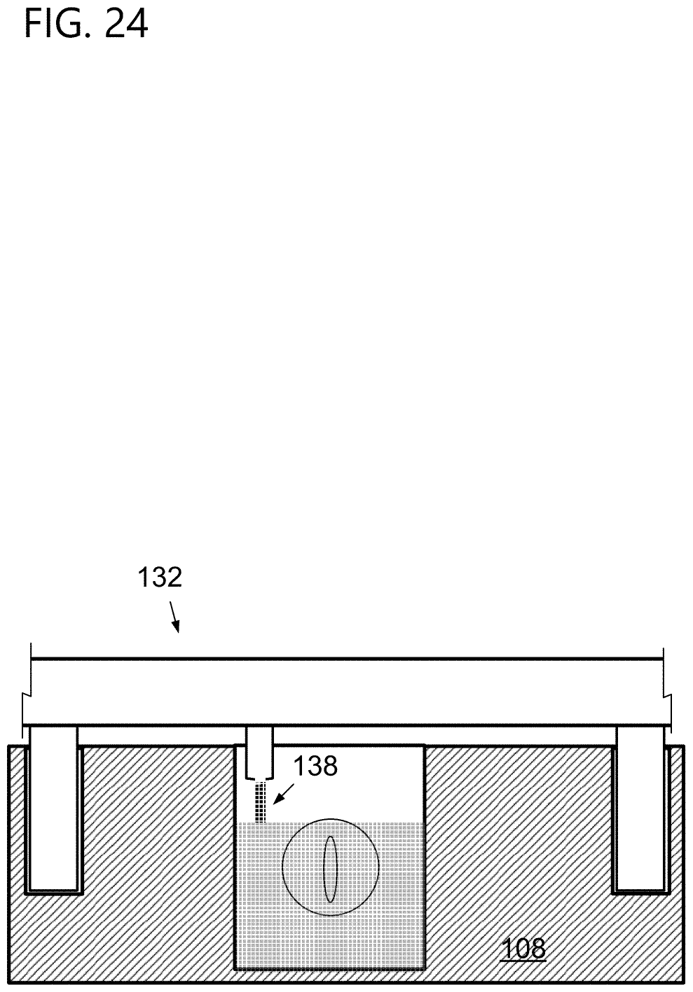

FIG. 35 is a photograph of an elevational view of a framework comprising a plurality of the gripping mechanisms and other components shown in FIG. 31; and FIG. 36 is a photograph of a perspective view of a bottom of the framework shown in FIG. 35.

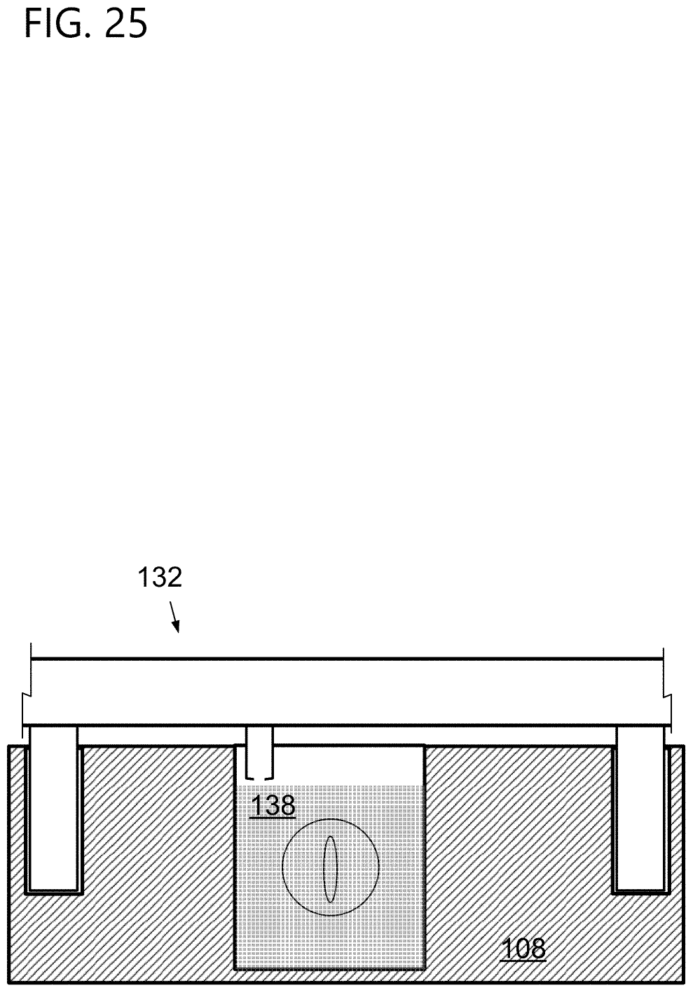

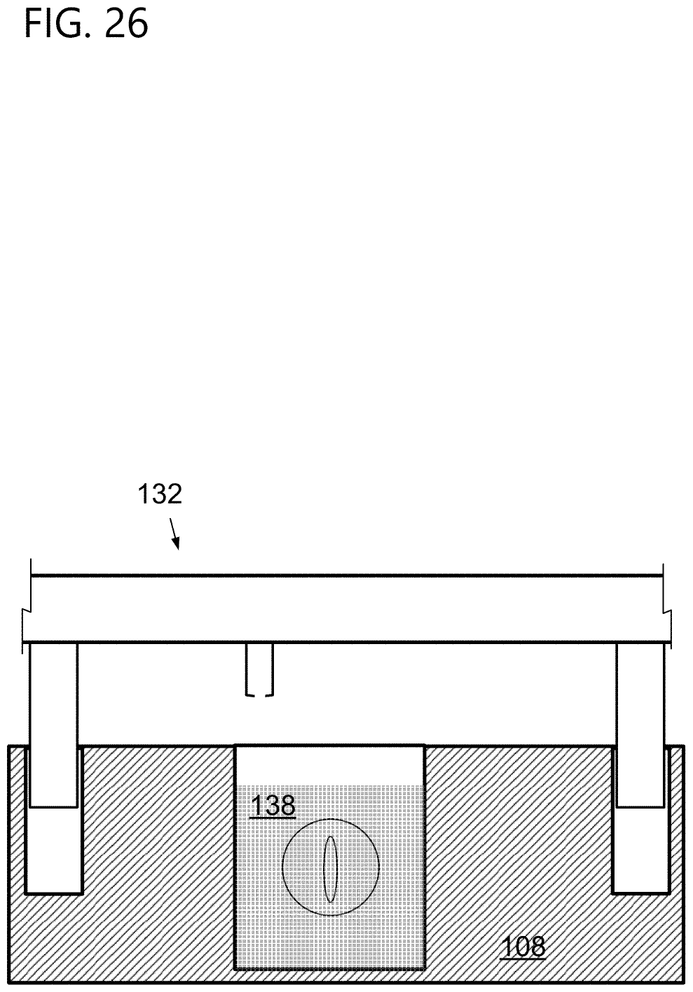

FIG. 37 is a photograph of a perspective view of a bottom of the framework of FIG. 35, wherein different color eyeballs are retained by the gripping mechanisms and have been property oriented for sinking into partially filled cavities of one or more molds. FIG. 38 is a photograph of an additional perspective view of the bottom of the framework of FIG. 37 including the retained eyeballs.

### Clip Prototype

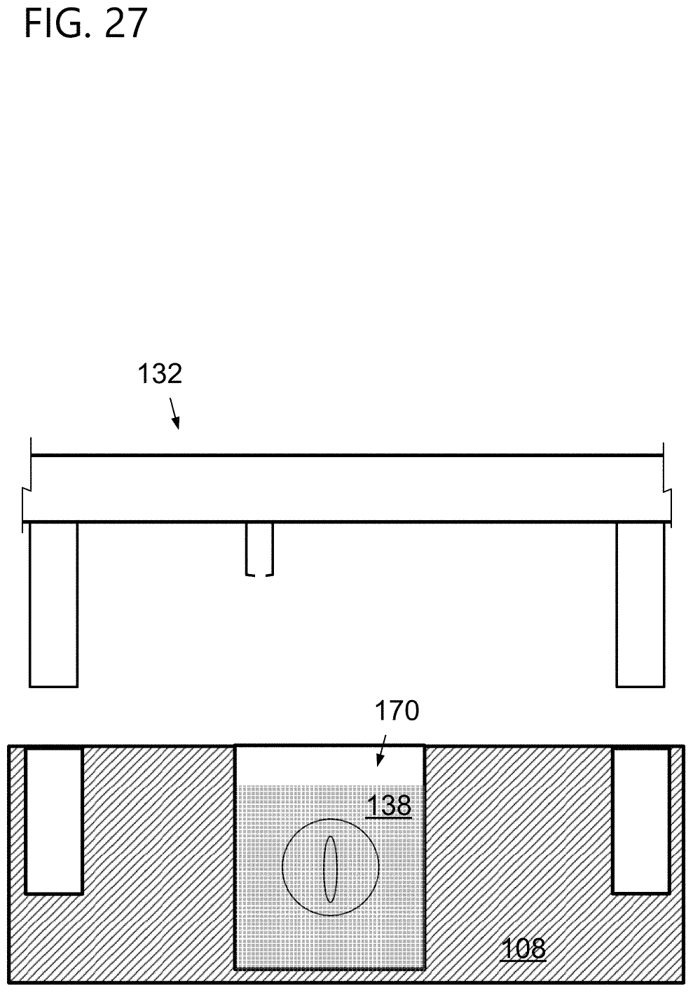

Yet another prototype of the invention is illustrated in FIGS. 39-50.

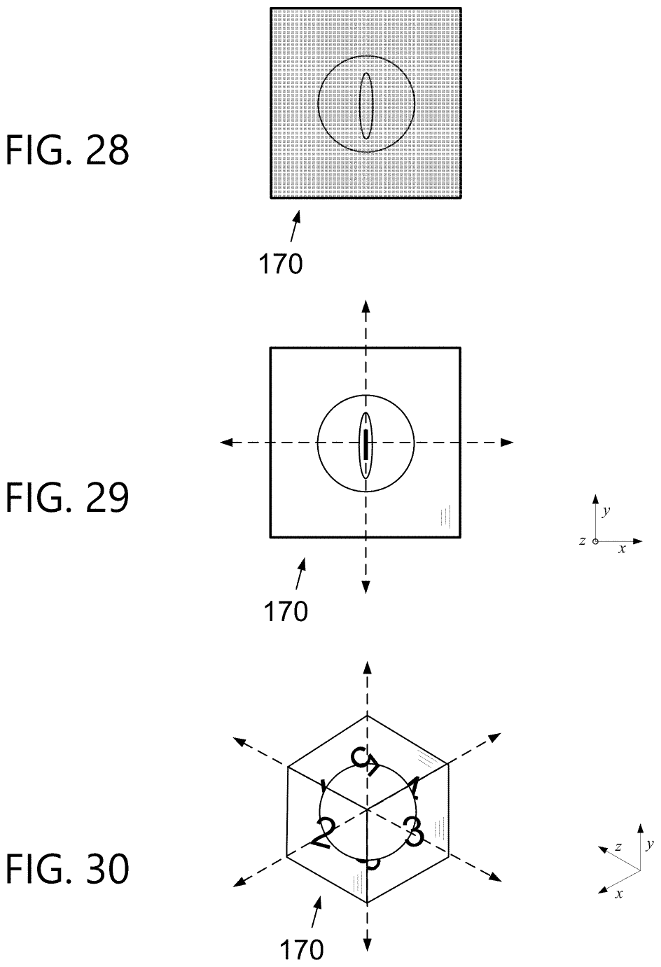

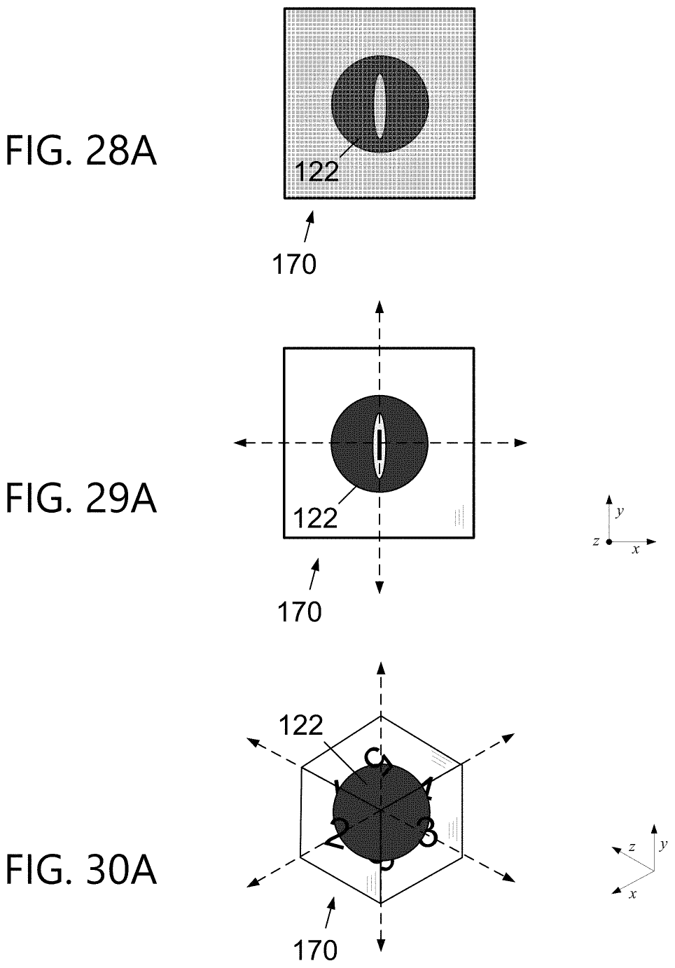

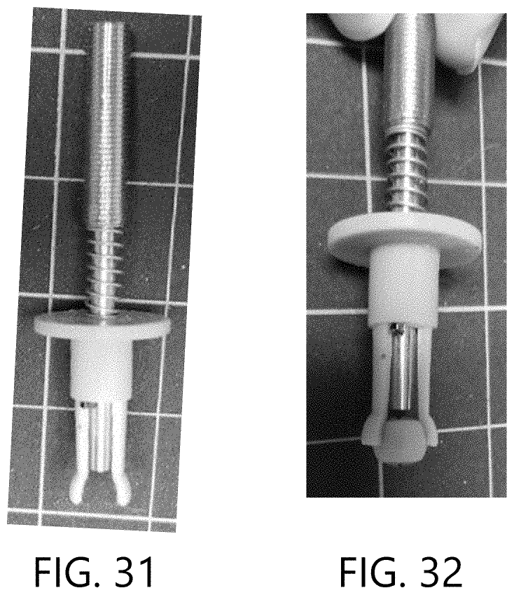

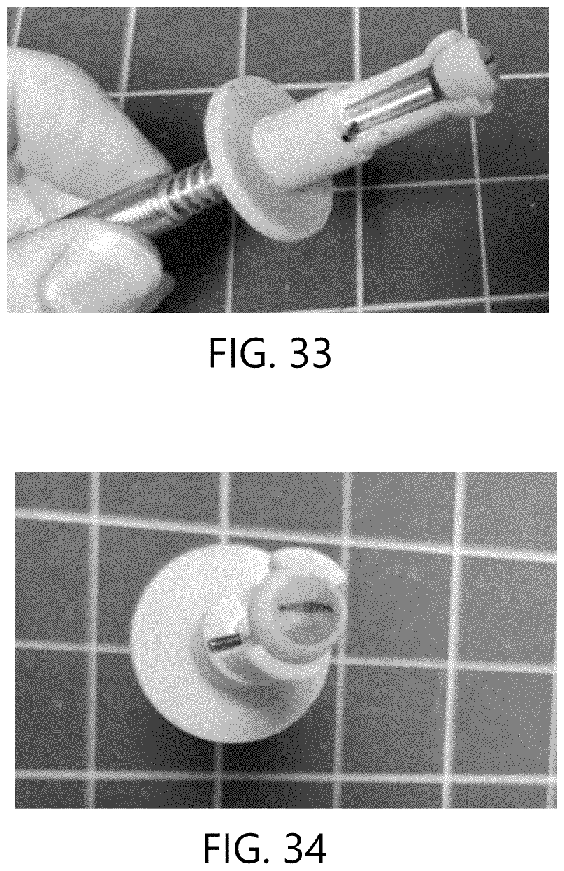

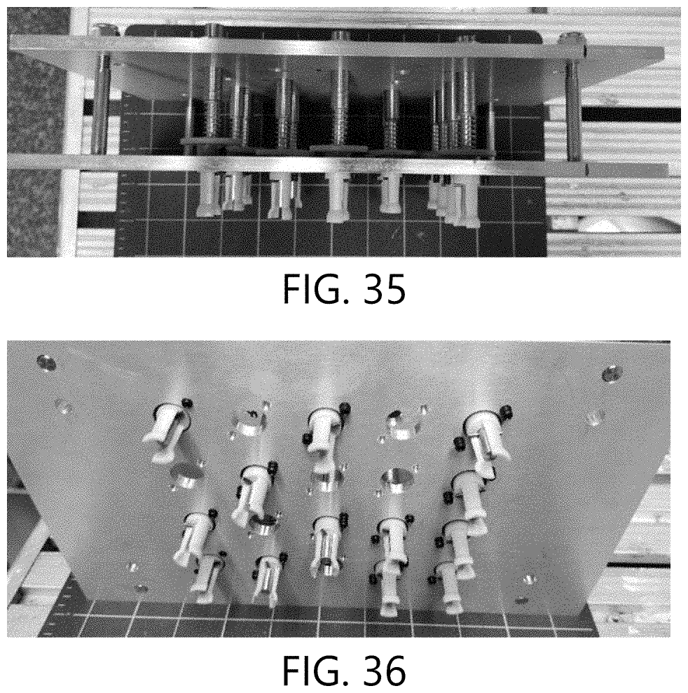

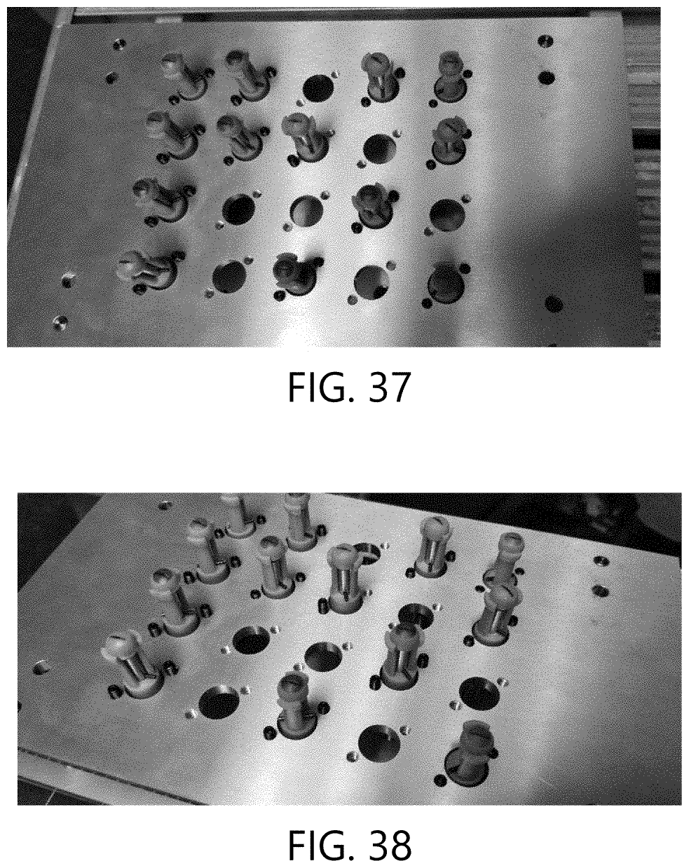

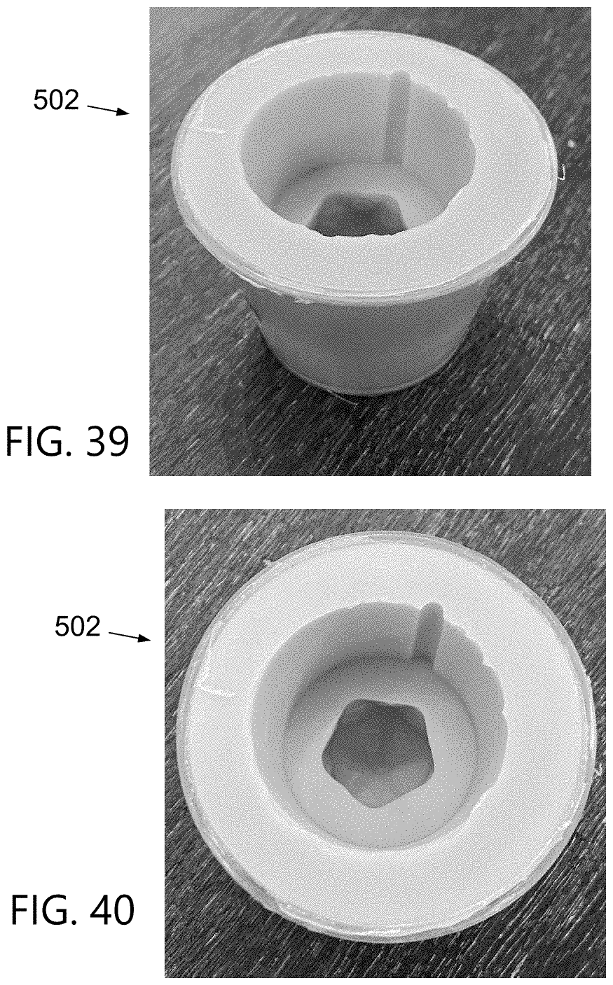

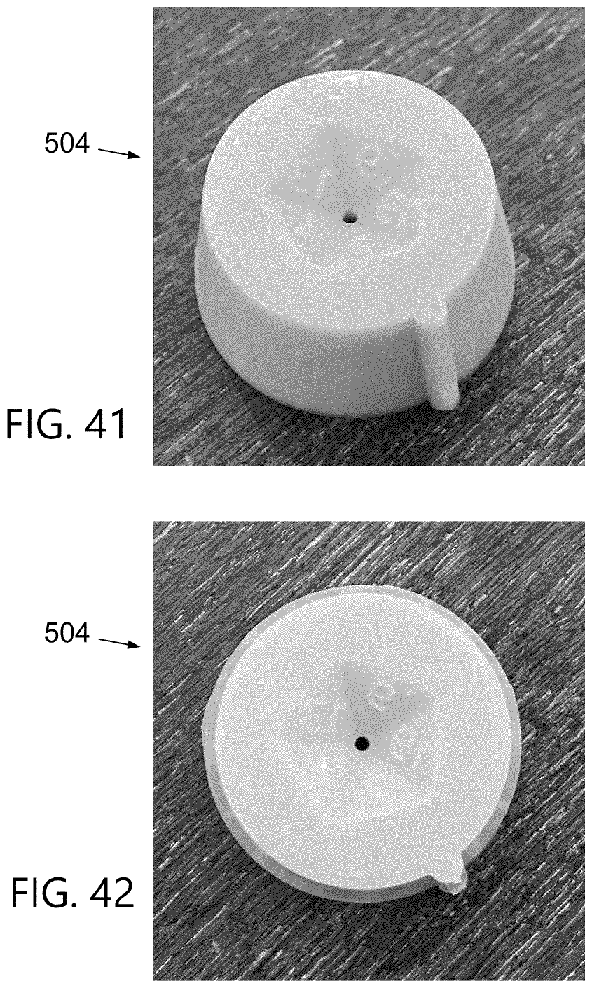

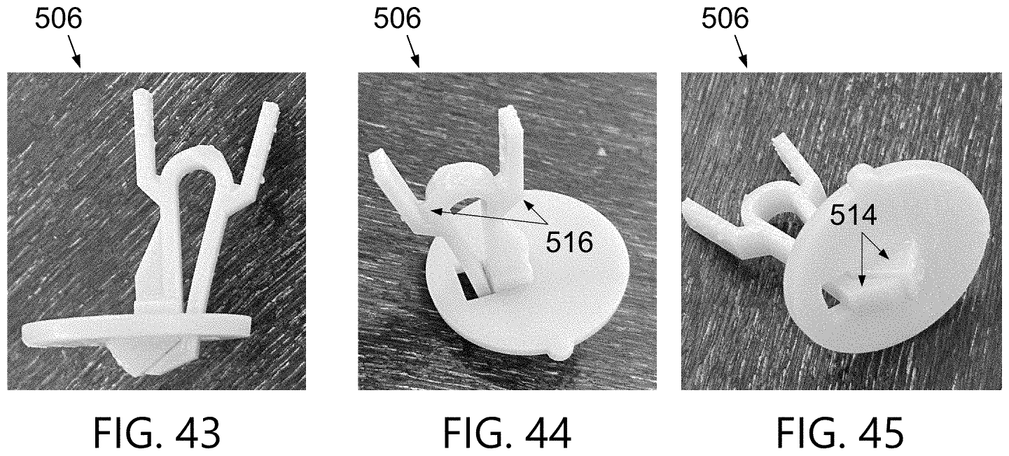

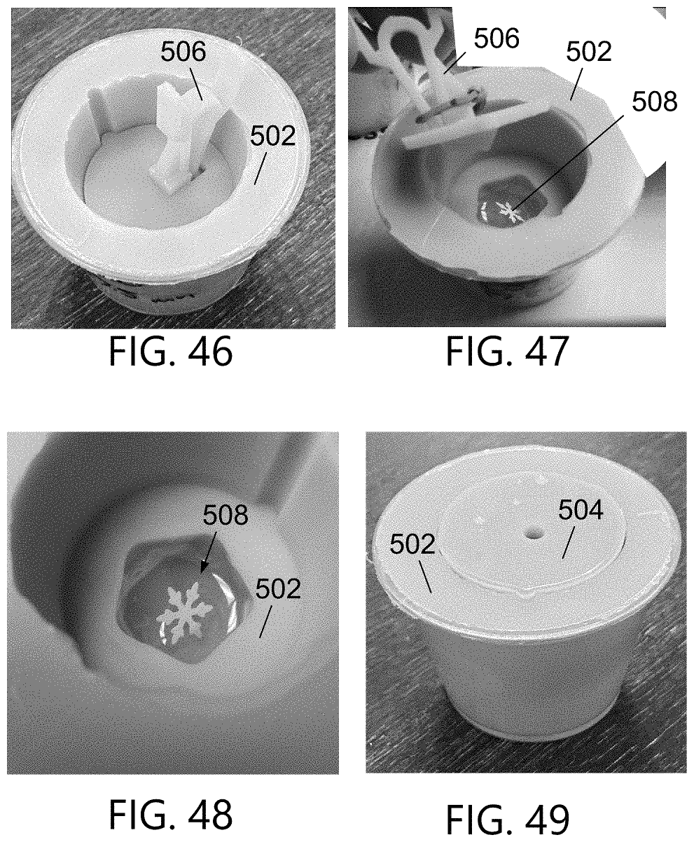

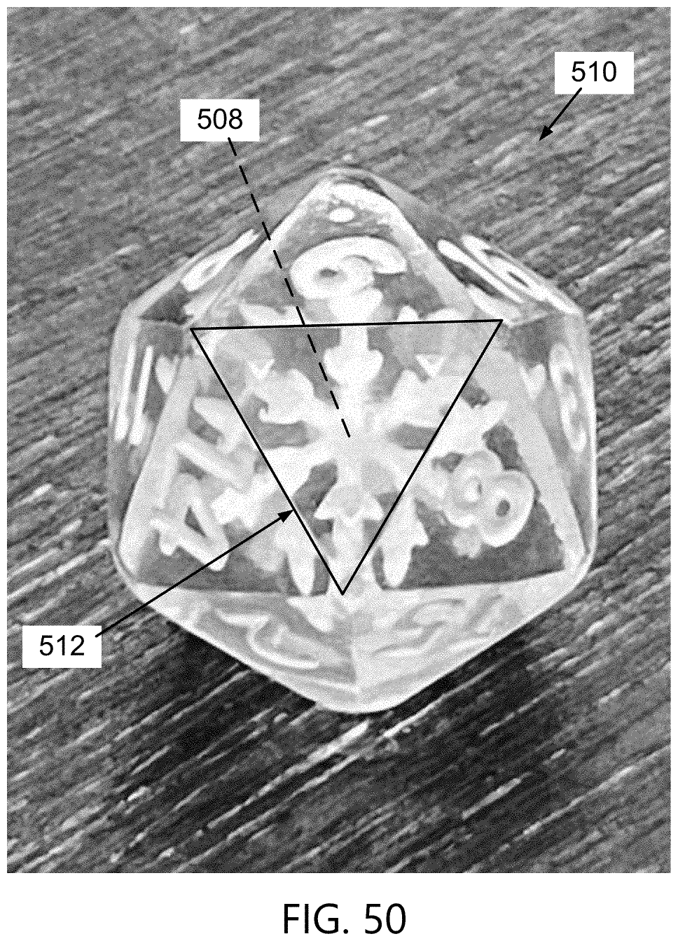

In particular, FIG. 39 is a perspective view of a lower mold component 502; FIG. 40 is a top perspective view of the mold component 502; FIG. 41 is a perspective view of a bottom of an upper mold component 504; FIG. 42 is a top perspective view of the bottom of the upper mold component 504; FIG. 43 is a side elevational view of a gripping mechanism 506 comprising a clip; FIG. 44 is a perspective view of a top of the gripping mechanism 506; FIG. 45 is a perspective view of a bottom of the gripping mechanism 506; FIG. 46 is a perspective view of the gripping mechanism 506 received in a predetermined orientation within a cavity of the lower mold component 502; FIG. 47 is a perspective view of the gripping mechanism 506 being manually withdrawn from the lower mold component 502 after suspension of an object 508 in the shape of a snowflake partially within a partially cured lower portion of a gaming die being molded; FIG. 48 is a perspective view of the object 508 suspended partially within the curing material in the cavity of the lower mold component 502; FIG. 49 is a perspective view after coupling of the upper mold component 504 and lower mold component 502, whereupon the cavity of the upper mold component 504 is filled and the material cured to fully form the die being molded; and FIG. 50 is a perspective view of the resulting molded die 510.

With specific reference to FIGS. 43-45, the clip of the gripping mechanism 506 includes opposing jaws or clamps 514 that are manually actuated by squeezing lever arms 516. The clip preferably is a single piece that itself is molded or printed and includes an inherent resiliency that biases the arms away from each other and the jaws towards each other. An additional biasing component may be included, such as a spring or band for supplementing or in substitution for such inherent biasing, if needed or desired.

As perhaps best seen in FIG. 50, the object 508 is located symmetrically with respect to a predetermined triangular face 512 of the die 510. This desired placement is readily replicated with each casting made in accordance with the foregoing apparatus and method described with reference to FIGS. 39-50.

Based on the foregoing description, it will be readily understood by those persons skilled in the art that the invention has broad utility and application. Many embodiments and adaptations of the invention other than those specifically described herein, as well as many variations, modifications, and equivalent arrangements, will be apparent from or reasonably suggested by the invention and the foregoing descriptions thereof, without departing from the substance or scope of the invention.

Accordingly, while the invention has been described herein in detail in relation to one or more preferred embodiments, it is to be understood that this disclosure is only illustrative and exemplary of the invention and is made merely for the purpose of providing a full and enabling disclosure of the invention. The foregoing disclosure is not intended to be construed to limit the invention or otherwise exclude any such other embodiments, adaptations, variations, modifications or equivalent arrangements, the invention being limited only by the claims appended hereto and the equivalents thereof.

1-32. (canceled)

33. A method of casting using a multi-cavity mold, comprising:
(a) partially filling a plurality of cavities of the multi-cavity mold with a liquid, the plurality of cavities comprising three or more cavities;
(b) simultaneously for each cavity that has been partially filled with the liquid, partially sinking an object into the liquid in said cavity; and
(c) after at least partially hardening of the liquid partially filled in said cavities with the objects partially sunk therein, fully immersing the objects that have been partially sunk by continuing to fill said cavities with the liquid, whereby upon further hardening a casting is formed in each said cavity having a respective said object embedded therein.

34. The method of claim 33, wherein said step of partially filling the plurality of cavities is performed simultaneously for each cavity.

35. The method of claim 33, wherein said step of fully immersing the objects is performed by simultaneously filling said cavities.

36. The method of claim 33, wherein at least a subset of said plurality of said cavities are identical in dimensions and orientation, and wherein identical objects are partially sunk into the liquid in said cavities of said subset, and wherein said identical objects have the same orientation relative to the direction of sinking.

37. The method of claim 33, wherein each casting formed in each said cavity is a die.

38. The method of claim 33, wherein the castings comprise dice.

39. The method of claim 33, wherein the castings comprise ice cubes.

40. The method of claim 33, wherein the objects are edible.

41. The method of claim 33, further comprising positioning the objects in gripping mechanisms suspended from a framework and using the framework to sink the objects within the liquid within the cavities, identical objects being identically oriented relative to their respective gripping mechanisms.

42. The method of claim 41, wherein the liquid comprises a resin.

43. The method of claim 41, wherein the liquid comprises water.

44. The method of claim 43, wherein the liquid is hardened by freezing.

45. The method of claim 41, wherein the liquid is hardened by heating.

46. The method of claim 41, wherein the liquid is hardened using a chemical.

47. A method of casting using a mold, comprising the steps of:
(a) suspending the object from a framework;
(b) partially filling a cavity of a mold with a liquid;
(c) positioning the framework over the mold such that the suspended object is sunk into the liquid partially filling the cavity of the mold; and
(d) after at least partial hardening of the liquid within the cavity of the mold with the object partially sunk into therein, fully immersing the object by continuing to fill the cavity with the liquid, whereby upon further hardening a casting is formed in the cavity having the object embedded therein.

48. An apparatus for embedding an object in a casting, comprising:
(a) a first mold component comprising a cavity for molding a first portion of an item to be molded;
(b) a gripping mechanism for suspending an object into the cavity for embedding the object partially within the first portion of the item to be molded, the gripping mechanism being configured to release the object upon actuation; and
(c) a second mold component comprising a cavity for molding a remaining portion of the item to be molded;
(d) wherein the first mold component is configured to interchangeably receive in respective predetermined orientations the gripping mechanism and the second mold component.

49. The apparatus of claim 48, wherein the gripping mechanism comprises a clip.

50. The apparatus of claim 48, wherein the gripping mechanism is biased into gripping engagement with the object.

51. The apparatus of claim 48, wherein the gripping mechanism is actuated by being pulled upward from the cavity of the first mold component.

52. The apparatus of claim 48, wherein the gripping mechanism is configured for manual removal from the first mold.

53-56. (canceled)
